(19) United States
(12) Patent Application Publication
(10) Pub. No.: US 2020/0322606 A1
(43) Pub. Date: Oct. 8, 2020

(54) SYSTEMS AND METHODS FOR DETERMINING QUANTIZATION PARAMETER PREDICTIVE VALUES

(71) Applicant: Sharp Kabushiki Kaisha, Sakai City, Osaka (JP)

(72) Inventors: Michael HOROWITZ, Vancouver, WA (US); Kiran Mukesh MISRA, Vancouver, WA (US); Jie ZHAO, Vancouver, WA (US); Christopher Andrew SEGALL, Vancouver, WA (US)

(21) Appl. No.: 16/756,615

(22) PCT Filed: Oct. 17, 2018
(86) PCT No.: PCT/JP2018/038721

§ 371 Date: Apr. 16, 2020

Related U.S. Application Data
(60) Provisional application No. 62/576,496, filed on Oct. 24, 2017.
(60) Provisional application No. 62/579,685, filed on Oct. 31, 2017.
(60) Provisional application No. 62/584,066, filed on Nov. 9, 2017.

(51) Int. Cl. H04N 19/126; H04N 19/176

(52) U.S. Cl. CPC H04N 19/126; H04N 19/176

(57) ABSTRACT

A video coding device may be configured to perform video coding according to one or more of the techniques described herein. In one example, a method of coding of video data comprises determining a predictive quantization parameter for an array of level values based at least in part on one or more of: a picture quantization map and a quantization parameter value of a video block included in a reference picture, generating a quantization parameter for the array based at least in part on the determined predictive quantization parameter, and performing an inverse quantization operation on the array using the generated quantization parameter.

### CROSS REFERENCE

This Nonprovisional application claims priority under 35 U.S.C. § 119 on provisional Application No. 62/576,496 on Oct. 24, 2017, Application No. 62/579,685 on Oct. 31, 2017, and Application No. 62/584,066 on Nov. 9, 2017, the entire contents of which are hereby incorporated by reference.

### TECHNICAL FIELD

This disclosure relates to video coding and more particularly to techniques for determining quantization parameter predictive values.

### BACKGROUND ART

Digital video capabilities can be incorporated into a wide range of devices, including digital televisions, laptop or desktop computers, tablet computers, digital recording devices, digital media players, video gaming devices, cellular telephones, including so-called smartphones, medical imaging devices, and the like. Digital video may be coded according to a video coding standard. Video coding standards may incorporate video compression techniques. Examples of video coding standards include ISO/IEC MPEG-4 Visual and ITU-T H.264 (also known as ISO/IEC MPEG-4 AVC) and High-Efficiency Video Coding (HEVC). HEVC is described in High Efficiency Video Coding (HEVC), Rec. ITU-T H.265 December 2016, which is incorporated by reference, and referred to herein as ITU-T H.265. Extensions and improvements for ITU-T H.265 are currently being considered for the development of next generation video coding standards. For example, the ITU-T Video Coding Experts Group (VCEG) and ISO/IEC (Moving Picture Experts Group (MPEG) (collectively referred to as the Joint Video Exploration Team (JVET)) are studying the potential need for standardization of future video coding technology with a compression capability that significantly exceeds that of the current HEVC standard. The Joint Exploration Model 6 (JEM 6), Algorithm Description of Joint Exploration Test Model 6 (JEM 6), ISO/IEC JTC1/SC29/WG11 Document: JVET-F1001v3, April 2017, Hobart, A U, which is incorporated by reference herein, describes the coding features that are under coordinated test model study by the JVET as potentially enhancing video coding technology beyond the capabilities of ITU-T H.265. It should be noted that the coding features of JEM 6 are implemented in JEM reference software. As used herein, the term JEM is used to collectively refer to algorithms included in JEM 6 and implementations of JEM reference software.

Video compression techniques enable data requirements for storing and transmitting video data to be reduced. Video compression techniques may reduce data requirements by exploiting the inherent redundancies in a video sequence. Video compression techniques may sub-divide a video sequence into successively smaller portions (i.e., groups of frames within a video sequence, a frame within a group of frames, slices within a frame, coding tree units (e.g., macroblocks) within a slice, coding blocks within a coding tree unit, etc.). Intra prediction coding techniques (e.g., intra-picture (spatial)) and inter prediction techniques (i.e., inter-picture (temporal)) may be used to generate difference values between a unit of video data to be coded and a reference unit of video data. The difference values may be referred to as residual data. Residual data may be coded as quantized transform coefficients. Syntax elements may relate residual data and a reference coding unit (e.g., intra-prediction mode indices, motion vectors, and block vectors). Residual data and syntax elements may be entropy coded. Entropy encoded residual data and syntax elements may be included in a compliant bitstream.

### SUMMARY OF INVENTION

In one example, a method of coding of video data comprises determining a predictive quantization parameter for an array of level values based at least in part on one or more of: a picture quantization map and a quantization parameter value of a video block included in a reference picture, generating a quantization parameter for the array based at least in part on the determined predictive quantization parameter, and performing an inverse quantization operation on the array using the generated quantization parameter.

### BRIEF DESCRIPTION OF DRAWINGS

FIG. 1 is a conceptual diagram illustrating an example of a group of pictures coded according to a quad tree binary tree partitioning in accordance with one or more techniques of this disclosure.

FIG. 2 is a conceptual diagram illustrating an example of a video component sampling format in accordance with one or more techniques of this disclosure.

FIG. 3 is a conceptual diagram illustrating possible coding structures for a block of video data according to one or more techniques of this disclosure.

FIG. 4A is a conceptual diagram illustrating an example of coding a block of video data in accordance with one or more techniques of this disclosure.

FIG. 4B is a conceptual diagram illustrating an example of coding a block of video data in accordance with one or more techniques of this disclosure.

FIG. 5 is a block diagram illustrating an example of a system that may be configured to encode and decode video data according to one or more techniques of this disclosure.

FIG. 6 is a block diagram illustrating an example of a video encoder that may be configured to encode video data according to one or more techniques of this disclosure.

FIG. 7 is a conceptual diagram illustrating an example of a picture where regions of the picture have relative perceptual relevance according to one or more techniques of this disclosure.

FIG. 8 is a conceptual diagram illustrating candidate video blocks included in a reference picture according to one or more techniques of this disclosure.

FIG. 9 is a block diagram illustrating an example of a video decoder that may be configured to decode video data according to one or more techniques of this disclosure.

### DESCRIPTION OF EMBODIMENTS

In general, this disclosure describes various techniques for coding video data. In particular, this disclosure describes techniques for determining quantization parameter predictive values. A quantization parameter predictive value may include a value that is used to determine a quantization parameter for a current video block. For example, for a group of quantized transform coefficients, a delta value may be added to a quantization parameter predictive to determine the quantization parameter to be used to perform inverse quantization on the group of quantized transform coefficients. As described in further detail below, the techniques for determining quantization parameter predictive values described herein may result in increased efficiency in video coding. It should be noted that although techniques of this disclosure are described with respect to ITU-T H.264, ITU-T H.265, and JEM, the techniques of this disclosure are generally applicable to video coding. For example, the coding techniques described herein may be incorporated into video coding systems, (including video coding systems based on future video coding standards) including block structures, intra prediction techniques, inter prediction techniques, transform techniques, filtering techniques, and/or entropy coding techniques other than those included in ITU-T H.265 and JEM. Thus, reference to ITU-T H.264, ITU-T H.265, and/or JEM is for descriptive purposes and should not be construed to limit the scope of the techniques described herein. Further, it should be noted that incorporation by reference of documents herein is for descriptive purposes and should not be construed to limit or create ambiguity with respect to terms used herein. For example, in the case where an incorporated reference provides a different definition of a term than another incorporated reference and/or as the term is used herein, the term should be interpreted in a manner that broadly includes each respective definition and/or in a manner that includes each of the particular definitions in the alternative.

In one example, a device for coding video data comprises one or more processors configured to determine a predictive quantization parameter for an array of level values based at least in part on one or more of: a picture quantization map and a quantization parameter value of a video block included in a reference picture, generate a quantization parameter for the array based at least in part on the determined predictive quantization parameter, and perform an inverse quantization operation on the array using the generated quantization parameter.

In one example, a non-transitory computer-readable storage medium comprises instructions stored thereon that, when executed, cause one or more processors of a device to determine a predictive quantization parameter for an array of level values based at least in part on one or more of: a picture quantization map and a quantization parameter value of a video block included in a reference picture, generate a quantization parameter for the array based at least in part on the determined predictive quantization parameter, and perform an inverse quantization operation on the array using the generated quantization parameter.

In one example, an apparatus comprises means for determining a predictive quantization parameter for an array of level values based at least in part on one or more of: a picture quantization map and a quantization parameter value of a video block included in a reference picture, means for generating a quantization parameter for the array based at least in part on the determined predictive quantization parameter, and means for performing an inverse quantization operation on the array using the generated quantization parameter.

The details of one or more examples are set forth in the accompanying drawings and the description below. Other features, objects, and advantages will be apparent from the description and drawings, and from the claims.

Video content typically includes video sequences comprised of a series of frames (or pictures). A series of frames may also be referred to as a group of pictures (GOP). Each video frame or picture may include a plurality of slices or tiles, where a slice or tile includes a plurality of video blocks. As used herein, the term video block may generally refer to an area of a picture or may more specifically refer to the largest array of sample values that may be predictively coded, sub-divisions thereof, and/or corresponding structures. Further, the term current video block may refer to an area of a picture being encoded or decoded. A video block may be defined as an array of sample values that may be predictively coded. It should be noted that in some cases pixel values may be described as including sample values of respective components of video data, which may also be referred to as color components, (e.g., luma (Y) and chroma (Cb and Cr) components or red, green, and blue components). It should be noted that in some cases, the terms pixel values and sample values are used interchangeably. Video blocks may be ordered within a picture according to a scan pattern (e.g., a raster scan). A video encoder may perform predictive encoding on video blocks and sub-divisions thereof. Video blocks and sub-divisions thereof may be referred to as nodes.

ITU-T H.264 specifies a macroblock structure including 16×16 luma samples. That is, in ITU-T H.264, a picture is segmented into macroblocks. ITU-T H.265 specifies an analogous Coding Tree Unit (CTU) structure, which may also be referred to as a largest coding unit (LCU). In ITU-T H.265, pictures are segmented into CTUs. In ITU-T H.265, for a picture, a CTU size may be set as including 16×16, 32×32, or 64×64 luma samples. In ITU-T H.265, a CTU is composed of respective Coding Tree Blocks (CTB) for each component of video data (e.g., luma (Y) and chroma (Cb and Cr)). Further, in ITU-T H.265, a CTU may be partitioned according to a quadtree (QT) partitioning structure, which results in the CTBs of the CTU being partitioned into Coding Blocks (CB). That is, in ITU-T H.265, a CTU may be partitioned into quadtree leaf nodes. According to ITU-T H.265, one luma CB together with two corresponding chroma CBs and associated syntax elements are referred to as a coding unit (CU). In ITU-T H.265, a minimum allowed size of a CB may be signaled. In ITU-T H.265, the smallest minimum allowed size of a luma CB is 8×8 luma samples. In ITU-T H.265, the decision to code a picture area using intra prediction or inter prediction is made at the CU level.

In ITU-T H.265, a CU is associated with a prediction unit (PU) structure having its root at the CU. In ITU-T H.265, PU structures allow luma and chroma CBs to be split for purposes of generating corresponding reference samples. That is, in ITU-T H.265, luma and chroma CBs may be split into respect luma and chroma prediction blocks (PBs), where a PB includes a block of sample values for which the same prediction is applied. In ITU-T H.265, a CB may be partitioned into 1, 2, or 4 PBs. ITU-T H.265 supports PB sizes from 64×64 samples down to 4×4 samples. In ITU-T H.265, square PBs are supported for intra prediction, where a CB may form the PB or the CB may be split into four square PBs (i.e., intra prediction PB sizes type include M×M or M/2×M/2, where M is the height and width of the square CB). In ITU-T H.265, in addition to the square PBs, rectangular PBs are supported for inter prediction, where a CB may by halved vertically or horizontally to form PBs (i.e., inter prediction PB types include M×M, M/2×M/2, M/2×M, or M×M/2). Further, it should be noted that in ITU-T H.265, for inter prediction, four asymmetric PB partitions are supported, where the CB is partitioned into two PBs at one quarter of the height (at the top or the bottom) or width (at the left or the right) of the CB (i.e., asymmetric partitions include M/4×M left, M/4×M right, M×M/4 top, and M×M/4 bottom). Intra prediction data (e.g., intra prediction mode syntax elements) or inter prediction data (e.g., motion data syntax elements) corresponding to a PB is used to produce reference and/or predicted sample values for the PB.

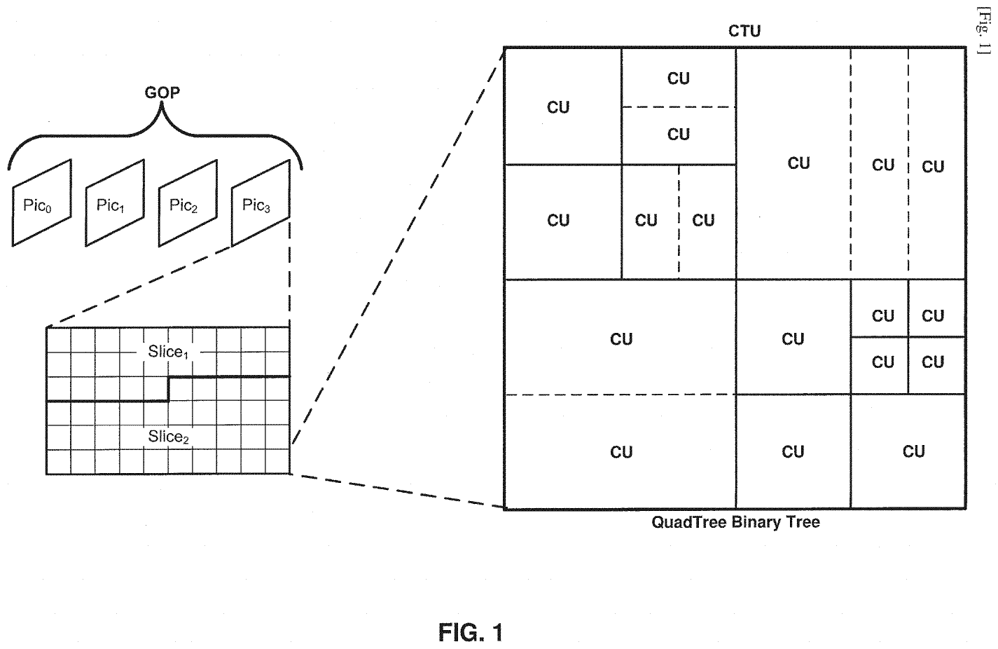

JEM specifies a CTU having a maximum size of 256×256 luma samples. JEM specifies a quadtree plus binary tree (QTBT) block structure. In JEM, the QTBT structure enables quadtree leaf nodes to be further partitioned by a binary tree (BT) structure. That is, in JEM, the binary tree structure enables quadtree leaf nodes to be recursively divided vertically or horizontally. FIG. 1 illustrates an example of a CTU (e.g., a CTU having a size of 256×256 luma samples) being partitioned into quadtree leaf nodes and quadtree leaf nodes being further partitioned according to a binary tree. That is, in FIG. 1 dashed lines indicate additional binary tree partitions in a quadtree. Thus, the binary tree structure in JEM enables square and rectangular leaf nodes, where each leaf node includes a CB. As illustrated in FIG. 1, a picture included in a GOP may include slices, where each slice includes a sequence of CTUs and each CTU may be partitioned according to a QTBT structure. FIG. 1 illustrates an example of QTBT partitioning for one CTU included in a slice.

In JEM, a QTBT is signaled by signaling QT split flag and BT split mode syntax elements. Further, in JEM, luma and chroma components may have separate QTBT partitions. That is, in JEM, luma and chroma components may be partitioned independently by signaling respective QTBTs. Currently, in JEM independent QTBT structures are enabled for slices using intra prediction techniques. In JEM, CBs are used for prediction without any further partitioning. That is, in JEM, a CB may be a block of sample values on which the same prediction is applied. Thus, a JEM QTBT leaf node may be analogous a PB in ITU-T H.265.

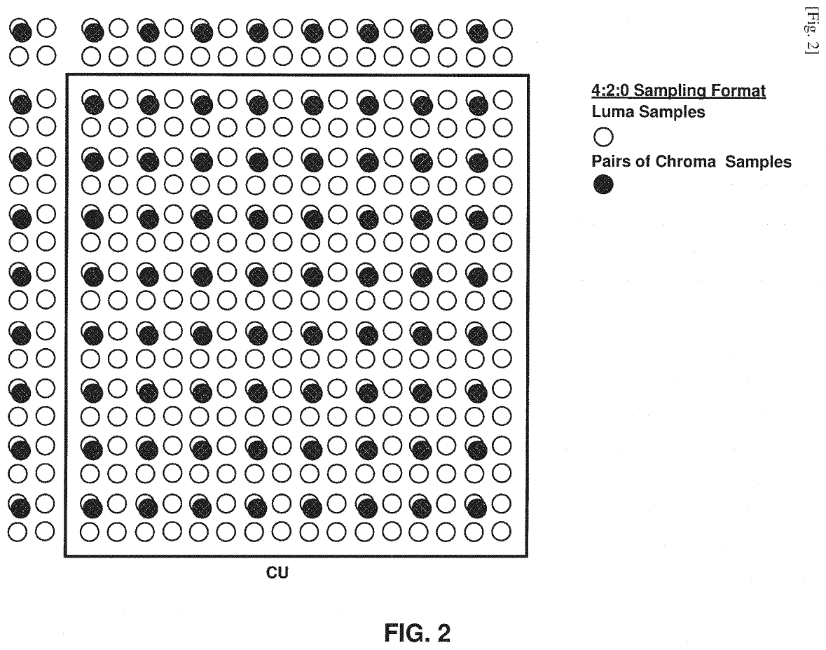

A video sampling format, which may also be referred to as a chroma format, may define the number of chroma samples included in a CU with respect to the number of luma samples included in a CU. For example, for the 4:2:0 sampling format, the sampling rate for the luma component is twice that of the chroma components for both the horizontal and vertical directions. As a result, for a CU formatted according to the 4:2:0 format, the width and height of an array of samples for the luma component are twice that of each array of samples for the chroma components. FIG. 2 is a conceptual diagram illustrating an example of a coding unit formatted according to a 4:2:0 sample format. FIG. 2 illustrates the relative position of chroma samples with respect to luma samples within a CU. As described above, a CU is typically defined according to the number of horizontal and vertical luma samples. Thus, as illustrated in FIG. 2, a 16×16 CU formatted according to the 4:2:0 sample format includes 16×16 samples of luma components and 8×8 samples for each chroma component. Further, in the example illustrated in FIG. 2, the relative position of chroma samples with respect to luma samples for video blocks neighboring the 16×16 CU are illustrated. For a CU formatted according to the 4:2:2 format, the width of an array of samples for the luma component is twice that of the width of an array of samples for each chroma component, but the height of the array of samples for the luma component is equal to the height of an array of samples for each chroma component. Further, for a CU formatted according to the 4:4:4 format, an array of samples for the luma component has the same width and height as an array of samples for each chroma component.

As described above, intra prediction data or inter prediction data is used to produce reference sample values for a block of sample values. The difference between sample values included in a current PB, or another type of picture area structure, and associated reference samples (e.g., those generated using a prediction) may be referred to as residual data. As described above, intra prediction data or inter prediction data may associate an area of a picture (e.g., a PB or a CB) with corresponding reference samples. For intra prediction coding, an intra prediction mode may specify the location of reference samples within a picture. In ITU-T H.265, defined possible intra prediction modes include a planar (i.e., surface fitting) prediction mode (predMode: 0), a DC (i.e., flat overall averaging) prediction mode (predMode: 1), and 33 angular prediction modes (predMode: 2-34). In JEM, defined possible intra-prediction modes include a planar prediction mode (predMode: 0), a DC prediction mode (predMode: 1), and 65 angular prediction modes (predMode: 2-66). It should be noted that planar and DC prediction modes may be referred to as non-directional prediction modes and that angular prediction modes may be referred to as directional prediction modes. It should be noted that the techniques described herein may be generally applicable regardless of the number of defined possible prediction modes.

For inter prediction coding, a motion vector (MV) identifies reference samples in a picture other than the picture of a video block to be coded and thereby exploits temporal redundancy in video. For example, a current video block may be predicted from reference block(s) located in previously coded frame(s) and a motion vector may be used to indicate the location of the reference block. A motion vector and associated data may describe, for example, a horizontal component of the motion vector, a vertical component of the motion vector, a resolution for the motion vector (e.g., one-quarter pixel precision, one-half pixel precision, one-pixel precision, two-pixel precision, four-pixel precision), a prediction direction and/or a reference picture index value. Further, a coding standard, such as, for example ITU-T H.265, may support motion vector prediction. Motion vector prediction enables a motion vector to be specified using motion vectors of neighboring blocks. Examples of motion vector prediction include advanced motion vector prediction (AMVP), temporal motion vector prediction (TMVP), so-called “merge” mode, and “skip” and “direct” motion inference. Further, JEM supports advanced temporal motion vector prediction (ATMVP), Spatial-temporal motion vector prediction (STMVP), Pattern matched motion vector derivation (PMMVD) mode, which is a special merge mode based on Frame-Rate Up Conversion (FRUC) techniques, and affine transform motion compensation prediction.

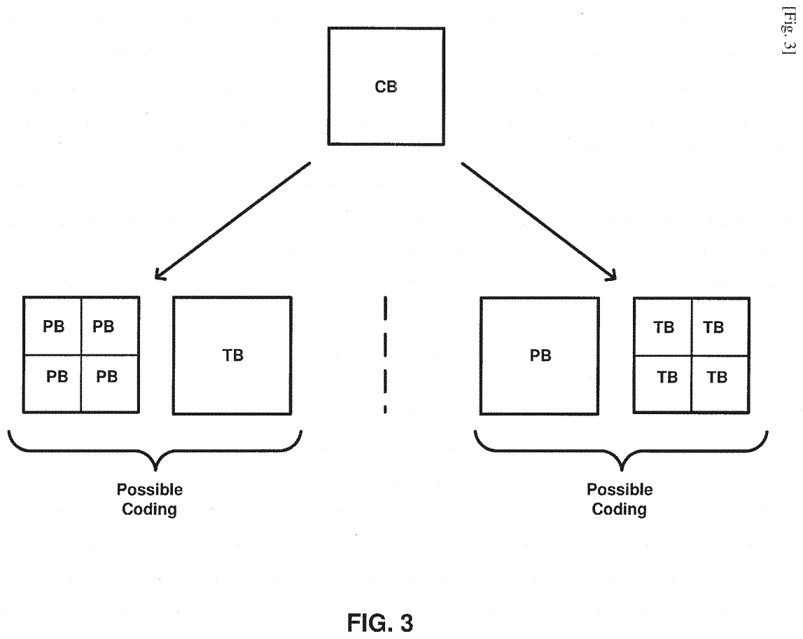

Residual data may include respective arrays of difference values corresponding to each component of video data. Residual data may be in the pixel domain. A transform, such as, a discrete cosine transform (DCT), a discrete sine transform (DST), an integer transform, a wavelet transform, or a conceptually similar transform, may be applied to an array of difference values to generate transform coefficients. In ITU-T H.265, a CU is associated with a transform unit (TU) structure having its root at the CU level. That is, in ITU-T H.265, an array of difference values may be sub-divided for purposes of generating transform coefficients (e.g., four 8×8 transforms may be applied to a 16×16 array of residual values). For each component of video data, such sub-divisions of difference values may be referred to as Transform Blocks (TBs). It should be noted that in ITU-T H.265, TBs are not necessarily aligned with PBs. FIG. 3 illustrates examples of alternative PB and TB combinations that may be used for coding a particular CB.

It should be noted that in JEM, residual values corresponding to a CB are used to generate transform coefficients without further partitioning. That is, in JEM a QTBT leaf node may be analogous to both a PB and a TB in ITU-T H.265. It should be noted that in JEM, a core transform and a subsequent secondary transforms may be applied (in the video encoder) to generate transform coefficients. For a video decoder, the order of transforms is reversed. Further, in JEM, whether a secondary transform is applied to generate transform coefficients may be dependent on a prediction mode.

A quantization process may be performed on transform coefficients. Quantization approximates transform coefficients by amplitudes restricted to a set of specified values. Quantization may be used in order to vary the amount of data required to represent a group of transform coefficients. Quantization may be realized through division of transform coefficients by a scaling factor and any associated rounding functions (e.g., rounding to the nearest integer). Quantized transform coefficients may be referred to as coefficient level values. Inverse quantization (or “dequantization”) may include multiplication of coefficient level values by the scaling factor. It should be noted that as used herein the term quantization process in some instances may refer to division by a scaling factor to generate level values or multiplication by a scaling factor to recover transform coefficients in some instances. That is, a quantization process may refer to quantization in some cases and inverse quantization in some cases. Further, it should be noted that although in some of the examples below quantization processes are described with respect to arithmetic operations associated with decimal notation, such descriptions are for illustrative purposes and should not be construed as limiting. For example, the techniques described herein may be implemented in a device using binary operations and the like. For example, multiplication and division operations described herein may be implemented using bit shifting operations and the like.

With respect to the equations used herein, the following arithmetic operators may be used:
+ Addition
− Subtraction
* Multiplication, including matrix multiplication
x^{y} Exponentiation. Specifies x to the power of y. In other contexts, such notation is used for superscripting not intended for interpretation as exponentiation.
/ Integer division with truncation of the result toward zero. For example, 7/4 and −7/−4 are truncated to 1 and −7/4 and 7/−4 are truncated to −1.
÷ Used to denote division in mathematical equations where no truncation or rounding is intended.

$$\frac{x}{y}$$

Used to denote division in mathematical equations where no truncation or rounding is intended.

$${\sum }_{i = x}^{y} f ( i )$$

The summation of f(i) with i taking all integer values from x up to and including y.
x % y Modulus. Remainder of x divided by y, defined only for integers x and y with x>=0 and y>0.

Further, the following logical operators may be used:
x && y Boolean logical “and” of x and y
x∥y Boolean logical “or” of x and y
! Boolean logical “not”
x? y:z If x is TRUE or not equal to 0, evaluates to the value of y; otherwise, evaluates to the value of z.

Further, the following relational operators may be used:
> Greater than
>= Greater than or equal to
< Less than
<= Less than or equal to
== Equal to
!= Not equal to

Further, the following bit-wise operators may be used:
& Bit-wise “and”. When operating on integer arguments, operates on a two's complement representation of the integer value. When operating on a binary argument that contains fewer bits than another argument, the shorter argument is extended by adding more significant bits equal to 0.
   | Bit-wise “or”. When operating on integer arguments, operates on a two's complement representation of the integer value. When operating on a binary argument that contains fewer bits than another argument, the shorter argument is extended by adding more significant bits equal to 0.
\hat{ } A Bit-wise “exclusive or”. When operating on integer arguments, operates on a two's complement representation of the integer value. When operating on a binary argument that contains fewer bits than another argument, the shorter argument is extended by adding more significant bits equal to 0.
x >> y Arithmetic right shift of a two's complement integer representation of x by y binary digits. This function is defined only for non-negative integer values of y. Bits shifted into the most significant bits (MSBs) as a result of the right shift have a value equal to the MSB of x prior to the shift operation.
x << y Arithmetic left shift of a two's complement integer representation of x by y binary digits. This function is defined only for non-negative integer values of y. Bits shifted into the least significant bits (LSBs) as a result of the left shift have a value equal to 0.

Further, the following mathematical functions may be used:

$$Log 2 ( x ) the base \text{-} 2 logarithm of x ;$$

$$Min ( x , y ) = \{ \begin{matrix}x ; & x <= y \\ y ; & x > y\end{matrix} ; \\ Max ( x , y ) = \{ \begin{matrix}x ; & x >= y \\ y ; & x < y\end{matrix}$$

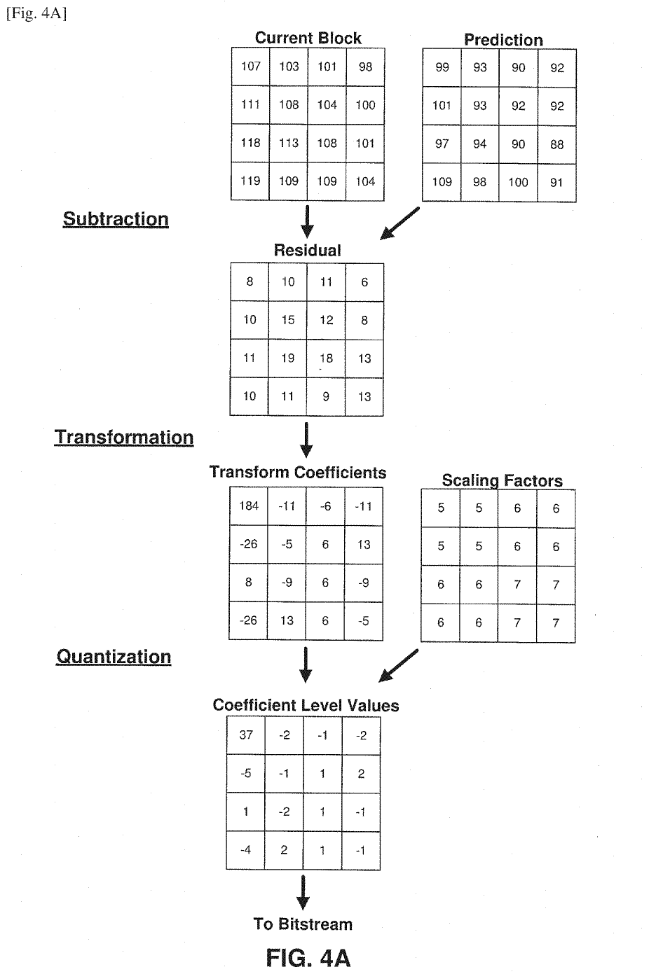

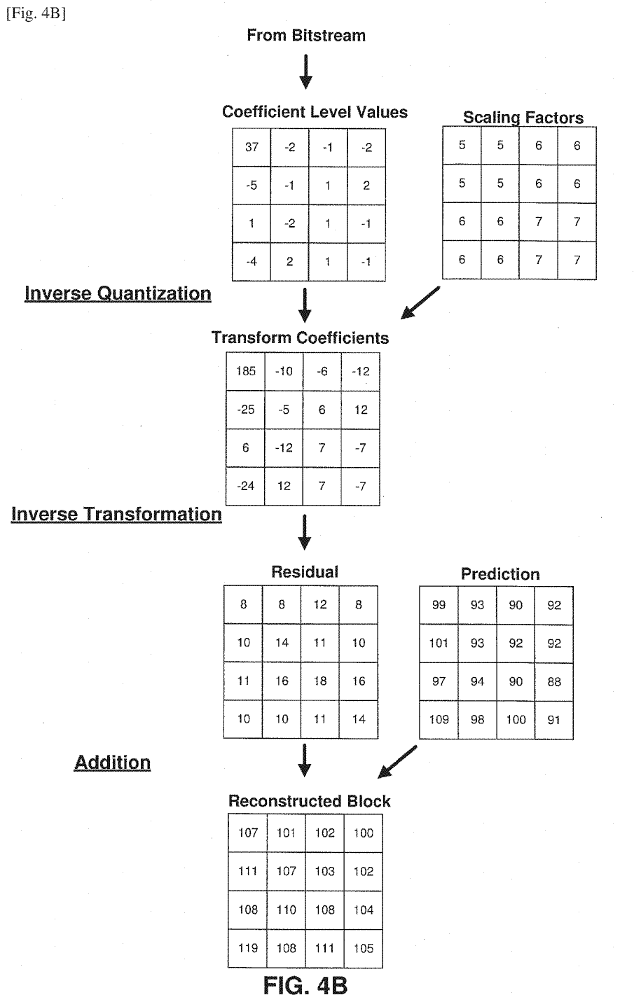

FIGS. 4A-4B are conceptual diagrams illustrating examples of coding a block of video data. As illustrated in FIG. 4A, a current block of video data (e.g., a CB corresponding to a video component) is encoded by generating a residual by subtracting a set of prediction values from the current block of video data, performing a transformation on the residual, and quantizing the transform coefficients to generate level values. As illustrated in FIG. 4B, the current block of video data is decoded by performing inverse quantization on level values, performing an inverse transform, and adding a set of prediction values to the resulting residual. It should be noted that in the examples in FIGS. 4A-4B, the sample values of the reconstructed block differ from the sample values of the current video block that is encoded. In this manner, coding may be said to be lossy. However, the difference in sample values may be considered acceptable to a viewer of the reconstructed video.

Further, as illustrated in FIGS. 4A-4B, scaling is performed using an array of scaling factors. In ITU-T H.265, an array of scaling factors is generated by selecting a scaling matrix and multiplying each entry in the scaling matrix by a quantization scaling factor. In ITU-T H.265, a scaling matrix is selected based in part on a prediction mode and a color component, where scaling matrices of the following sizes are defined: 4×4, 8×8, 16×16, and 32×32. It should be noted that in some examples, a scaling matrix may provide the same value for each entry (i.e., all coefficients are scaled according to a single value). In ITU-T H.265, the value of a quantization scaling factor, may be determined by a quantization parameter, QP. In ITU-T H.265, for a bit-depth of 8-bits, the QP can take 52 values from 0 to 51 and a change of 1 for QP generally corresponds to a change in the value of the quantization scaling factor by approximately 12%. It should be noted that more generally, in ITU-T H.265, the valid range of QP values for a source bit-depth is: −6*(bitdepth−8) to +51 (inclusive). Thus, for example, in the case where the bit-depth is 10-bits, QP can take 64 values from −12 to 51, which may be mapped to values 0 to 63 during dequantization.

Further, in ITU-T H.265, a QP value for a set of transform coefficients may be derived using a predictive quantization parameter value (which may be referred to as a predictive QP value or a QP predictive value) and an optionally signaled quantization parameter delta value (which may be referred to as a QP delta value or a delta QP value). In ITU-T H.265, a quantization parameter may be updated for each CU and a respective quantization parameter may be derived for each of luma (Y) and chroma (Cb and Cr) components. In ITU-T H.265, for a current CU, a predictive QP value is inherited for the CU (i.e., a QP signaled at the slice level or a QP from a previous CU) and a delta QP value may be optionally signaled for each TU within the CU. For the luma component, the QP for each luma TB is the sum of the predictive QP value and any signaled delta QP value. Further, for most profiles in ITU-T H.265, for the chroma components of the current CU, the chroma QP is a function of the QP determined for the luma component and chroma QP offsets signaled in a slice header and/or chroma QP offsets signaled a picture parameter set (PPS).

The dequantization process defined in ITU-T H.265 for each entry in an x by y array may be summarized as follows:
d[x][y]=((TransCoeffLevel[x][y]*m[x][y]*levelScale[qP %6]<<(qP/6))+(1<<(bdShift−1)))>>bdShift

where
d[x][y] is a resulting transform coefficient;
TransCoeffLevel[x][y] is a coefficient level value;
m[x][y] is a scaling matrix;
levelScale[k]={40, 45, 51, 57, 64, 72} with k=0.5;
qP is the quantization parameter;
bdShift=BitDepth+Log 2 (nTbS)+10;
BitDepth is the bit depth of the corresponding component; and
nTbS specifies the size of the corresponding transform block.

It should be noted that the transform coefficient at d[0][0] is the DC transform coefficient and the other transform coefficients in the array are the AC transform coefficients.

As described above, in ITU-T H.265, for the luma component, the QP for each luma TB is the sum of the predictive QP value and any signaled delta QP value. In particular, for a current CU, a video decoder may derive the value of the luma QP based on a prediction derived from the QP values of neighboring CUs. That is, in ITU-T H.265, the luma QP, Qp′Y, is derived as follows:
Qp′_{Y}=Qp_{Y}+QpBdOffset_{Y};

where
Qp_{Y}=((qP_{Y_PRED}+CuQpDeltaVal+52+2*QpBdOffset_{Y})%(52+QpBdOffset_{Y}))−QpBdOffset_{Y};

where
qP_{Y_PRED}=qP_{Y_A}+qP_{Y_B}+1)>>1;

where
qP_{Y_A} in most cases, is set equal to the Q_{pY} of the coding unit to the left of the current CU;
qP_{Y_B} in most cases, is set equal to the Q_{pY} of the coding unit above the current CU;

where
CuQpDeltaVal=cu_qp_delta_abs*(1−2*cu_qp_delta_sign_flag);

where
cu_qp_delta_abs is a syntax element that is conditionally included in a bitstream at the Transform Unit Level that specifies the absolute value of the difference CuQpDeltaVal between the luma quantization parameter of the current coding unit and its prediction.
cu_qp_delta_sign_flag is a syntax element that is conditionally included in a bitstream at the Transform Unit Level that specifies the sign of CuQpDeltaVal as follows:
   If cu_qp_delta_sign_flag is equal to 0, the corresponding CuQpDeltaVal has a positive value.
   Otherwise (cu_qp_delta_sign_flag is equal to 1), the corresponding CuQpDeltaVal has a negative value.

where
QpBdOffset_{Y}=6*bit_depth_luma_minus8;

where
bit_depth_luma_minus8 is a syntax element included in a bitstream at the sequence level that specifies the value of the luma quantization parameter range offset QpBdOffsetY and shall be in the range of 0 to 8, inclusive.

It should be noted, in some cases, qPY_A and qPY_B may be set equal to a variable qP_{Y_PREV}, for example, when a neighboring block is unavailable. In ITU-T H.265, qP_{Y_PREV} is set equal to the QpY of the last coding unit in the previous quantization group in decoding order or is set equal to SliceQp_{Y}, which is determined based on the syntax element slice_qp_delta signaled in the bitstream at the slice header, where
slice_qp_delta specifies the initial value of QpY to be used for the coding blocks in the slice until modified by the value of CuQpDeltaVal in the coding unit layer. The initial value of the QpY quantization parameter for the slice, SliceQpY, is derived as follows:
   SliceQpY=26+init_qp_minus26+slice_qp_delta
The value of SliceQpY shall be in the range of −QpBdOffsetY to +51, inclusive.

As described above, quantization may be used in order to vary the amount of data required to represent a group of transform coefficients. For example, a quantization parameter value may be used to generate zero-valued coefficient levels for a number of transform coefficients in an array. It typically requires less data to represent an array of level values including fewer non-zero level values in a bitstream compared to an array of level values including more non-zero level values. It should be noted that in some cases, non-zero level values may be referred to as significant level values. However, as the degree of quantization increases (e.g., transform coefficients are divided by a larger scaling factor value), the amount of distortion may be increased (e.g., reconstructed video data may appear more “blocky” to a user). Typically, the amount of data required to code video data is expressed as a bit-rate and, as such, the tradeoff between the amount of data required to code video data and the amount of distortion may be referred to as a rate-distortion.

Thus, the QP value may be described as controlling the amount of error in a region of reconstructed video when compared to a source video, where finer quantization results in less error and a relatively higher bit-rate and coarser quantization results in more error and a relatively lower bit-rate. Spatially varying (i.e., from region-to-region in a picture) and/or temporally varying (i.e., from picture-to-picture in a coded video sequence) the QP value may be useful in practice to: adjust the bit-rate of a coded video sequence; reduce error (and thus, increase bit-rate) in visually important regions of a picture (e.g., the foreground of a scene); and increase error (and thus, decrease bit-rate) in visually unimportant regions of a picture (e.g., the background of a scene). QP adjustments may also be used to achieve a desired bit-rate. For example, rate control (RC) algorithms may refer to algorithms that code video data according to a specified bit-rate. For example, a rate control algorithm may seek to minimize error for a maximum allowable bit-rate (e.g., 5 Megabits per Second (Mb/s)). RC algorithms performed by a video encoder frequently use the statistical variance of a residual to select a QP value. It should be noted that as used herein the term bit-rate overhead may refer to the number of bits allocated in a bitstream to signal the value of a control parameter. For example, in ITU-T H.265 the delta QP value is signaled using the cu_qp_delta_abs and cu_qp_delta_sign_flag syntax elements. The bits allocated in the bitstream to convey the values of cu_qp_delta_abs and cu_qp_delta_sign_flag may be considered bit-rate overhead.

Thus, in practice, video encoders modulate the QP from CU-to-CU in order to control the allocation of bits to different CUs throughout a picture and there are several reasons for modulating the QP including: to re-shape quantization (e.g., luma-based modulation to reshape noise based on luma level), to allocate bit-rate as a function of picture content activity (e.g., variance-based modulation), and to allocate different bit-rates to different regions of a picture independent of content (location-based modulation). However, it should be noted that when modulating the QP value from CU-to-CU to a desired QP value, the value of the qP_{Y_PRED} for a current CU can be quite different from the desired QP value for the current CU. Thus, with respect to ITU-T H.265, in order to obtain a desired QP value for each particular CU included in a picture of video data, frequent signaling of cu_qp_delta_abs and cu_qp_delta_sign_flag may be required. Frequent signaling of cu_qp_delta_abs and cu_qp_delta_sign_flag may be less than ideal due to the resulting bit-rate overhead.

The frequency at which cu_qp_delta_abs and cu_qp_delta_sign_flag are signaled and the number of bits required to signal cu_qp_delta_abs may be based on how closely qP_{Y_PRED} matches the desired QP value. That is, qP_{Y_PRED} may be described in terms of accuracy compared to a desired QP value. Techniques are described herein to determine quantization parameter predictive values in a manner that increases the accuracy of a quantization parameter predictive value. Increasing the accuracy of a quantization parameter predictive value may result in cu_qp_delta_abs and cu_qp_delta_sign_flag being signaled less frequently and may result in using fewer bits to signal cu_qp_delta_abs and cu_qp_delta_sign_flag. Further, it should be noted that the techniques described herein to determine quantization parameter predictive values may be used with various techniques for signaling quantization parameter delta values. For example, the techniques described herein to determine quantization parameter predictive values may be used with the signaling of a quantization parameter delta values as described in ITU-T H.265 and additionally, may be used with other techniques for signaling quantization parameter delta values, including techniques described herein.

Referring again to FIG. 4A, quantized transform coefficients are coded into a bitstream. Quantized transform coefficients and syntax elements (e.g., syntax elements indicating a coding structure for a video block) may be entropy coded according to an entropy coding technique. Examples of entropy coding techniques include content adaptive variable length coding (CAVLC), context adaptive binary arithmetic coding (CABAC), probability interval partitioning entropy coding (PIPE), and the like. Entropy encoded quantized transform coefficients and corresponding entropy encoded syntax elements may form a compliant bitstream that can be used to reproduce video data at a video decoder. An entropy coding process may include performing a binarization on syntax elements. Binarization refers to the process of converting a value of a syntax value into a series of one or more bits. These bits may be referred to as “bins.” Binarization is a lossless process and may include one or a combination of the following coding techniques: fixed length coding, unary coding, truncated unary coding, truncated Rice coding, Golomb coding, k-th order exponential Golomb coding, and Golomb-Rice coding. For example, binarization may include representing the integer value of 5 for a syntax element as 00000101 using an 8-bit fixed length binarization technique or representing the integer value of 5 as 11110 using a unary coding binarization technique. As used herein each of the terms fixed length coding, unary coding, truncated unary coding, truncated Rice coding, Golomb coding, k-th order exponential Golomb coding, and Golomb-Rice coding may refer to general implementations of these techniques and/or more specific implementations of these coding techniques. For example, a Golomb-Rice coding implementation may be specifically defined according to a video coding standard, for example, ITU-T H.265.

As described above, cu_qp_delta_abs and cu_qp_delta_sign_flag are syntax elements that may be conditionally included in a bitstream generated according to ITU-T H.265. cu_qp_delta_sign_flag is a fixed length 1-bit syntax element that may have a value of 0 or 1 and has is inferred to have value of 0 when it is not present in the bitstream.

In ITU-T H.265, the binarization of the syntax element cu_qp_delta_abs is a concatenation of a prefix bin string and (when present) a suffix bin string. For the derivation of the prefix bin string, the following applies:
The prefix value of cu_qp_delta_abs, prefixVal, is derived as follows:
   prefixVal=Min(cu_qp_delta_abs, 5)
The prefix bin string is specified by invoking a truncated Rice coding process for prefixVal with cMax=5 and cRiceParam=0.
When prefixVal is greater than 4, the suffix bin string is present and it is derived as follows:
   The suffix value of cu_qp_delta_abs, suffixVal, is derived as follows:
      suffixVal=cu_qp_delta_abs−5
   The suffix bin string is specified by invoking a k-th exponential Golomb coding process for suffixVal with the Exp-Golomb order k set equal to 0.

An entropy coding process further includes coding bin values using lossless data compression algorithms. In the example of a CABAC, for a particular bin, a context model may be selected from a set of available context models associated with the bin. In some examples, a context model may be selected based on a previous bin and/or values of previous syntax elements. A context model may identify the probability of a bin having a particular value. For instance, a context model may indicate a 0.7 probability of coding a 0-valued bin and a 0.3 probability of coding a 1-valued bin. It should be noted that in some cases the probability of coding a 0-valued bin and probability of coding a 1-valued bin may not sum to 1. After selecting an available context model, a CABAC entropy encoder may arithmetically code a bin based on the identified context model. The context model may be updated based on the value of a coded bin. The context model may be updated based on an associated variable stored with the context, e.g., adaptation window size, number of bins coded using the context. It should be noted, that according to ITU-T H.265, a CABAC entropy encoder may be implemented, such that some syntax elements may be entropy encoded using arithmetic encoding without the usage of an explicitly assigned context model, such coding may be referred to as bypass coding. Further, it should be noted that more accurate QP predictions yield more predictable values of cu_qp_delta_abs. More predictable values of cu_qp_delta_abs have lower entropy than less predictable values of cu_qp_delta_abs (i.e., when QP prediction is less accurate). Typically, entropy encoding requires fewer bits to convey a lower entropy signal. Thus, more accurate QP predictive values may result in a reduced bit-rate, as the number of bits required to signal cu_qp_delta_abs may be reduced.

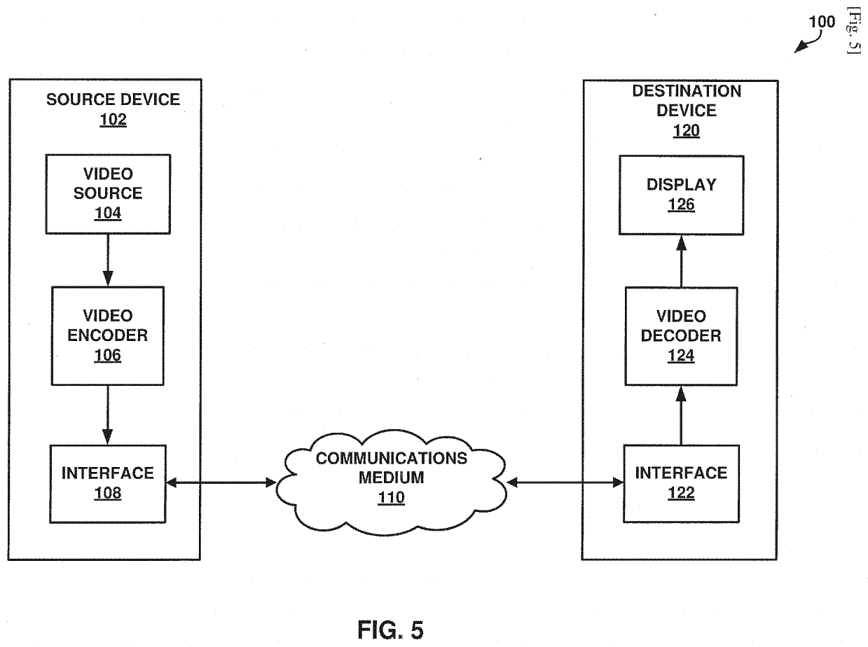

FIG. 5 is a block diagram illustrating an example of a system that may be configured to code (i.e., encode and/or decode) video data according to one or more techniques of this disclosure. System 100 represents an example of a system that may perform video coding using one or more of the techniques for determining quantization parameter predictive values as described herein. As illustrated in FIG. 5, system 100 includes source device 102, communications medium 110, and destination device 120. In the example illustrated in FIG. 5, source device 102 may include any device configured to encode video data and transmit encoded video data to communications medium 110. Destination device 120 may include any device configured to receive encoded video data via communications medium 110 and to decode encoded video data. Source device 102 and/or destination device 120 may include computing devices equipped for wired and/or wireless communications and may include set top boxes, digital video recorders, televisions, desktop, laptop, or tablet computers, gaming consoles, mobile devices, including, for example, “smart” phones, cellular telephones, personal gaming devices, and medical imagining devices.

Communications medium 110 may include any combination of wireless and wired communication media, and/or storage devices. Communications medium 110 may include coaxial cables, fiber optic cables, twisted pair cables, wireless transmitters and receivers, routers, switches, repeaters, base stations, or any other equipment that may be useful to facilitate communications between various devices and sites. Communications medium 110 may include one or more networks. For example, communications medium 110 may include a network configured to enable access to the World Wide Web, for example, the Internet. A network may operate according to a combination of one or more telecommunication protocols. Telecommunications protocols may include proprietary aspects and/or may include standardized telecommunication protocols. Examples of standardized telecommunications protocols include Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, Global System Mobile Communications (GSM) standards, code division multiple access (CDMA) standards, 3rd Generation Partnership Project (3GPP) standards, European Telecommunications Standards Institute (ETSI) standards, Internet Protocol (IP) standards, Wireless Application Protocol (WAP) standards, and Institute of Electrical and Electronics Engineers (IEEE) standards.

Storage devices may include any type of device or storage medium capable of storing data. A storage medium may include a tangible or non-transitory computer-readable media. A computer readable medium may include optical discs, flash memory, magnetic memory, or any other suitable digital storage media. In some examples, a memory device or portions thereof may be described as non-volatile memory and in other examples portions of memory devices may be described as volatile memory. Examples of volatile memories may include random access memories (RAM), dynamic random access memories (DRAM), and static random access memories (SRAM). Examples of non-volatile memories may include magnetic hard discs, optical discs, floppy discs, flash memories, or forms of electrically programmable memories (EPROM) or electrically erasable and programmable (EEPROM) memories. Storage device(s) may include memory cards (e.g., a Secure Digital (SD) memory card), internal/external hard disk drives, and/or internal/external solid state drives. Data may be stored on a storage device according to a defined file format.

Referring again to FIG. 5, source device 102 includes video source 104, video encoder 106, and interface 108. Video source 104 may include any device configured to capture and/or store video data. For example, video source 104 may include a video camera and a storage device operably coupled thereto. Video encoder 106 may include any device configured to receive video data and generate a compliant bitstream representing the video data. A compliant bitstream may refer to a bitstream that a video decoder can receive and reproduce video data therefrom. Aspects of a compliant bitstream may be defined according to a video coding standard. When generating a compliant bitstream video encoder 106 may compress video data. Compression may be lossy (discernible or indiscernible) or lossless. Interface 108 may include any device configured to receive a compliant video bitstream and transmit and/or store the compliant video bitstream to a communications medium. Interface 108 may include a network interface card, such as an Ethernet card, and may include an optical transceiver, a radio frequency transceiver, or any other type of device that can send and/or receive information. Further, interface 108 may include a computer system interface that may enable a compliant video bitstream to be stored on a storage device. For example, interface 108 may include a chipset supporting Peripheral Component Interconnect (PCI) and Peripheral Component Interconnect Express (PCIe) bus protocols, proprietary bus protocols, Universal Serial Bus (USB) protocols, I²C, or any other logical and physical structure that may be used to interconnect peer devices.

Referring again to FIG. 5, destination device 120 includes interface 122, video decoder 124, and display 126. Interface 122 may include any device configured to receive a compliant video bitstream from a communications medium. Interface 108 may include a network interface card, such as an Ethernet card, and may include an optical transceiver, a radio frequency transceiver, or any other type of device that can receive and/or send information. Further, interface 122 may include a computer system interface enabling a compliant video bitstream to be retrieved from a storage device. For example, interface 122 may include a chipset supporting PCI and PCIe bus protocols, proprietary bus protocols, USB protocols, I²C, or any other logical and physical structure that may be used to interconnect peer devices. Video decoder 124 may include any device configured to receive a compliant bitstream and/or acceptable variations thereof and reproduce video data therefrom. Display 126 may include any device configured to display video data. Display 126 may comprise one of a variety of display devices such as a liquid crystal display (LCD), a plasma display, an organic light emitting diode (OLED) display, or another type of display. Display 126 may include a High Definition display or an Ultra High Definition display. It should be noted that although in the example illustrated in FIG. 5, video decoder 124 is described as outputting data to display 126, video decoder 124 may be configured to output video data to various types of devices and/or sub-components thereof. For example, video decoder 124 may be configured to output video data to any communication medium, as described herein.

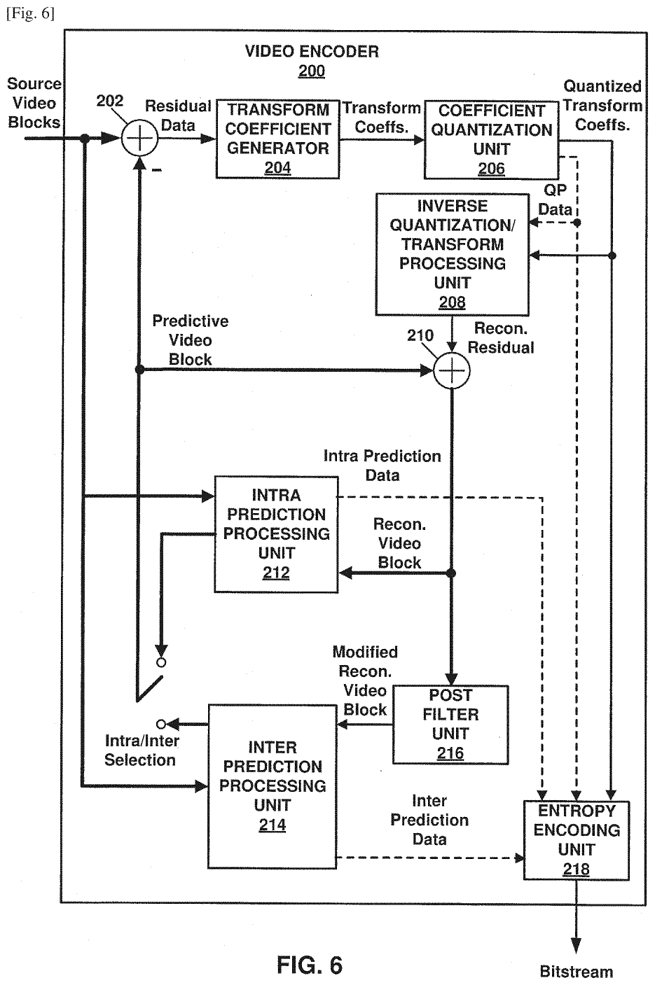

FIG. 6 is a block diagram illustrating an example of video encoder 200 that may implement the techniques for encoding video data described herein. It should be noted that although example video encoder 200 is illustrated as having distinct functional blocks, such an illustration is for descriptive purposes and does not limit video encoder 200 and/or sub-components thereof to a particular hardware or software architecture. Functions of video encoder 200 may be realized using any combination of hardware, firmware, and/or software implementations. In one example, video encoder 200 may be configured to encode video data according to the techniques described herein. Video encoder 200 may perform intra prediction coding and inter prediction coding of picture areas, and, as such, may be referred to as a hybrid video encoder. In the example illustrated in FIG. 6, video encoder 200 receives source video blocks and outputs a bitstream. In some examples, source video blocks may include areas of picture that has been divided according to a coding structure. For example, source video data may include macroblocks, CTUs, CBs, sub-divisions thereof, and/or another equivalent coding unit. In some examples, video encoder 200 may be configured to perform additional sub-divisions of source video blocks. It should be noted that some techniques described herein may be generally applicable to video coding, regardless of how source video data is partitioned prior to and/or during encoding.

In the example illustrated in FIG. 6, video encoder 200 includes summer 202, transform coefficient generator 204, coefficient quantization unit 206, inverse quantization/transform processing unit 208, summer 210, intra prediction processing unit 212, inter prediction processing unit 214, post filter unit 216, and entropy encoding unit 218. Video encoder 200 may generate residual data by subtracting a predictive video block from a source video block. Summer 202 represents a component configured to perform this subtraction operation. Transform coefficient generator 204 applies a transform, such as a discrete cosine transform (DCT), a discrete sine transform (DST), or a conceptually similar transform, to the residual block or sub-divisions thereof (e.g., four 8×8 transforms may be applied to a 16×16 array of residual values) to produce a set of transform coefficients. Transform coefficient generator 204 may be configured to perform any and all combinations of the transforms included in the family of discrete trigonometric transforms. As described above, in ITU-T H.265, TBs are restricted to the following sizes 4×4, 8×8, 16×16, and 32×32. In one example, transform coefficient generator 204 may be configured to perform transformations according to arrays having sizes of 4×4, 8×8, 16×16, and 32×32. In one example, transform coefficient generator 204 may be further configured to perform transforms according to arrays having other dimensions. Transform coefficient generator 204 may output transform coefficients to coefficient quantization unit 206.

Coefficient quantization unit 206 may be configured to perform quantization of the transform coefficients. Coefficient quantization unit 206 may be configured to determine quantization parameters and output QP data (e.g., data used to determine quantization parameter predictive values and/or delta QP values) that may be used by a video decoder to determine a predictive QP value and thus, reconstruct a quantization parameter to perform inverse quantization during video decoding. As described above, in ITU-T H.265, the degree of quantization may be modulated on a CU-by-CU basis by adjusting a predictive quantization parameter using a delta QP value. As further, described above, more accurate QP predictive values may result in a reduced bit-rate, as the frequency at which cu_qp_delta_abs and cu_qp_delta_sign_flag are signaled and the number of bits required to signal cu_qp_delta_abs may be reduced.

In one example, according to the techniques described herein, coefficient quantization unit 206 may be configured to compute predictive QP values according to one of several possible QP prediction techniques, which may be referred to as QP prediction modes. It should be noted that although some examples below are described with respect to qPY_PRED the techniques described herein may be equally applicable to computing predictive QP values for other components of video data. Thus, in the examples below, qPY_PRED in some cases, may be replaced with a predictive value corresponding to one or both chroma components of video data.

As described in further detail below, video encoder 200 may be configured to signal the QP prediction mode that is used to compute qPY_PRED (e.g., in the slice header, PPS, SPS) such that a video decoder uses the same QP prediction mode to compute qPY_PRED. Further, it should be noted that in some examples, a QP prediction mode may be signaled at multiple levels of a bitstream. For example, a QP prediction mode may be signaled in the PPS and updated using signaling at the slice header. Further, it should be noted that in some examples, a QP prediction mode may determine the manner in which a delta QP value is signaled. For example, a QP prediction mode may determine a binarization used for cu_qp_delta_abs.

As described above, in ITU-T H.265, qP_{Y_PRED} is typically computed as:
qP_{Y_PRED}=(qP_{Y_A}+qP_{Y_B}+1)>>1
   where
qP_{Y_A} in most cases, is set equal to the Q_{pY} of the coding unit to the left of the current CU;
qP_{Y_B} in most cases, is set equal to the Q_{pY} of the coding unit above the current CU.

However, in some cases, as noted above, each of qP_{Y_A} and qP_{Y_B} may be set equal to a variable qP_{Y_PREV}, where qP_{Y_PREV} is set equal to the Qp_{Y} of the last coding unit in the previous quantization group in decoding order or is set equal to SliceQp_{Y}. Such calculations of qP_{Y_PRED} may be less than ideal because the last CU in the previous quantization group in decoding order may not be spatially close to the current CU and might therefore not serve as a good predictor. According to the techniques described herein, in one example qP_{Y_PRED} may be computed as follows:
qP_{Y_PRED}=(qP_{Y_A}+qP_{Y_B}+1)>>1; when both qP_{Y_A} and qP_{Y_B} are available;
qP_{Y_PRED}=qP_{Y_A}; when only qP_{Y_A} is available;
qP_{Y_PRED}=qP_{Y_B}; when only qP_{Y_B} is available; or
qP_{Y_PRED}=SliceQp_{Y}; when neither of qP_{Y_A} and qP_{Y_B} are available.

Computing qP_{Y_PRED} in this manner may result in more accurate values for qP_{Y_PRED} compared to techniques described in ITU-T H.265 for computing qP_{Y_PRED}. Computing qP_{Y_PRED} in this manner, or in the manner described in ITU-T H.265 may generally be referred to as a qP_{Y_PRED}=func(qP_{Y_A}, qP_{Y_B}) QP prediction mode. That is, in these cases qP_{Y_PRED} is a function of qP_{Y_A} and qP_{Y_B}.

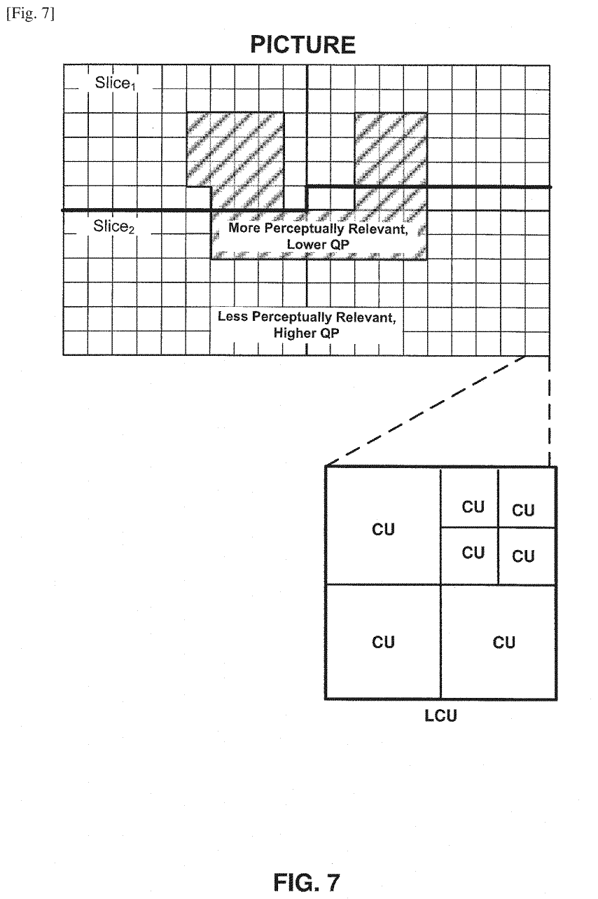

As described above, some regions of a picture are more perceptually relevant than others (e.g., foreground vs. background of a scene) and regions with more perceptual relevance are typically encoded using a relatively lower QP value. In some cases, the perceptual relevance of a region may be a relatively slow changing (or non-changing) function of the location of the CU in the picture. For example, the center region of a picture (i.e., multiple LCUs located at the center of a picture) may include the foreground of a scene and may be more perceptual relevant than regions of the picture outside of the center, as is typical in some video conferencing applications. FIG. 7 is a conceptual diagram illustrating an example of a picture where multiple contiguous LCUs located around the center of a picture are more perceptually relevant than other regions of the picture. It should be noted that in the example illustrated in FIG. 7, the multiple contiguous LCUs located around the center of the picture cross a slice boundary. In other examples, multiple contiguous LCUs having a similar perceptual relevance may or may not cross slice boundaries.

According to techniques described herein, in one example, coefficient quantization unit 206 may be configured to determine the perceptual relevance of a region of a picture (e.g., determine the perceptual relevance of each LCU or a contiguous set of LCUs) and thus determine the desired QP value for the region of a picture. In one example, coefficient quantization unit 206 may be configured to determine the perceptual relevance of a region of a picture by measuring statistical properties of video data. Coefficient quantization unit 206 may be further configured to specify a value used for computing a predictive QP value (e.g., qPY_PRED) for each region of the picture. In one example, coefficient quantization unit 206 may be configured to specify a value used for computing a predictive QP value (e.g., qPY_PRED) for each region of the picture according to a picture quantization map. In one example, a picture quantization map may be signaled using syntax elements included in a PPS.

In one example, a picture quantization map may include a two-dimensional array, dQPMap[picWidth][picHeight], where picWidth and picHeight represent the width of a picture and the height of a picture, respectively, in units of LCUs. In one example, each of the entries of dQPMap[x][y] include values used to compute a predictive QP value for all of the CUs included in the particular LCU (x,y). Thus, in one example, the value of qPY_PRED for each respective LCU (x,y) may be computed as:
qP_{Y_PRED}=Slice Qp_{Y}+dQPMap[x][y];
where SliceQP_{Y} is the QP for the slice containing LCU (x,y); and
dQPMap[x][y] specifies the difference between the luma quantization parameter of the LCU and sliceQP_{Y}.

In one example, information included in each of the elements of dQPMap[x][y] may include syntax elements similar to cu_qp_delta_sign_flag and cu_qp_delta_abs described above. It should be noted that the values of dQPMap[x][y] may be negative in some examples.

In one example, when a picture quantization map is used to compute a predictive QP value (e.g., qPY_PRED) for each region of the picture, signaling of delta QP values for each CU may be disabled. That is, cu_qp_delta_sign_flag and cu_qp_delta_abs may be excluded from a bitstream. Thus, in this example, the QP value for all of the CUs included in the particular LCU (x,y) may simply be qPY_PRED as calculated according to dQPMap[x][y].

In one example, when a picture quantization map is used to compute a predictive QP value (e.g., qPY_PRED) for each region of the picture, signaling of delta QP values for each CU may be enabled. That is, the luma QP, Qp′Y, may be computed in manner similar to that described above, with respect to ITU-T H.265. It should be noted that in this case, the range on cu_qp_delta_abs may be reduced such that signaling of cu_qp_delta_abs requires less bit-rate overhead.

In one example, information included in each of the elements of dQPMap[x][y] may include syntax elements similar to cu_qp_delta_sign_flag and cu_qp_delta_abs at entry dQPMap[0][0] and information included in subsequent entries (e.g., according to a predefined scan order) may include information indicating a change related to the value provided for the previous dQPMap[x][y] entry. That is, dQPMap[x][y] may use delta coding to indicate values for each dQPMap[x][y]. As described above, in one example, coefficient quantization unit 206 may be configured to determine the perceptual relevance of a contiguous set of LCUs. Thus, using delta coding to indicate values for each dQPMap[x][y] where a contiguous set of LCUs have a similar perceptual relevance may increase coding efficiency. For example, if consecutive LCUs in a predefined scan have the same value for qP_{Y_PRED}, dQPMap[x][y] values may be signaled as 0 (i.e., no change occurs from the previous value of dQPMap[x][y]).

As described above, a QP prediction mode may determine a binarization used for cu_qp_delta_abs. In one example, when each of the entries of a dQPMap[x][y] are used to compute a predictive QP value for all of the CUs included in the particular LCU (x,y), the range of cu_qp_delta_abs may be limited such that signaling of cu_qp_delta_abs requires less bit-rate overhead. Further, the binarization of cu_qp_delta_abs may be based on the range of cu_qp_delta_abs.

As described above, in one example, a picture quantization map may be signaled using syntax elements included in a PPS. Further, in one example, the values of dQPMap[x][y] signaled using syntax elements in the PPS (or other signaling at the picture level), may be modified for each slice by signaling a dQPChangeMap at the slice level. Examples of dQPChangeMap include:
1. dQPChangeMap[ ] [ ] where element dQPChangeMap[x] [y] corresponds to element dQPMap[x] [y] and the delta QP map is modified as follows:
   dQPMap[x] [y]=dQPMap[x] [y]+dQPChangeMap[x] [y];
2. dQPChangeRow[y] where each element in dQPMap[x] [y] may be modified as follows:
   dQPMap[x] [y]=dQPMap[x] [y]+dQPChangeRow[y];
3. dQPChangeCol[x] where each element in dQPMap[x] [y] may be modified as follows:
   dQPMap[x] [y]=dQPMap[x] [y]+dQPChangeCol[x];
4. dQPChangePic is a single value that modifies all elements in dQPMap[x] [y] as follows:
   dQPMap[x] [y]=dQPMap[x][y]+dQPChangePic;

Thus, in one example, when a dQPChangeMap is signaled at the slice level the value of qPY_PRED for each respective LCU (x,y) may be computed as:
qP_{Y_PRED}=SliceQp_{Y}+dQPMap[x] [y];
where dQPMap[x] [y] is computed according to a dQPChangeMap, for example, as provided in examples 1-4 above.

In one example, when a picture quantization map and a dQPChangeMap is used to compute a predictive QP value (e.g., qPY_PRED) for each region of the picture, the signaling of delta QP values for each CU may be disabled. That is, cu_qp_delta_sign_flag and cu_qp_delta_abs may be excluded from a bitstream. In one example, when a picture quantization map and a dQPChangeMap is used to compute a predictive QP value (e.g., qPY_PRED) for each region of the picture, signaling of delta QP values for each CU may be enabled. That is, the luma QP, Qp′Y, may be computed as described above. It should be noted that in this case, the range on cu_qp_delta_abs may be limited and/or the binarization of cu_qp_delta_abs may be selected such that signaling of cu_qp_delta_abs requires less bit-rate overhead.

In one example, dQPMap[x] [y] may be defined as a 2-D array in units of CUs instead of LCUs. An advantage of defining dQPMap[x] [y] as a 2-D array in units of CUs instead of LCUs is finer granularity specification of delta QP values. A disadvantage of defining dQPMap[x] [y] as a 2-D array in units of CUs instead of LCUs is that the map size can be large in terms of bits. Computing qP_{Y_PRED} using a dQPMap[x] [y] may generally be referred to as a qP_{Y_PRED}=func func(dQPMap[x] [y]) QP prediction mode. That is, in these cases qP_{Y_PRED} is a function of dQPMap[x][y].

As described above, in some cases, the perceptual relevance of a region may be a relatively slow changing (or non-changing) function of the location of the CU in the picture. In a similar manner, the perceptual relevance of a region may be a relatively slow changing on a temporal basis. That is, for example, there may be a high correlation between the perceptual relevance of collocated regions from picture-to-picture. Thus, according to the techniques described herein, for a region in a current picture, a predictive QP value may be derived from a QP value of a collocated region in a reference picture. In one example, the predictive QP value for a current CB (or CU) may be derived from a QP value of a collocated CB (or CU) in a reference picture. In one example, a QP value of a collocated CB (or CU) in a reference picture may be referred to as a collocated QP value and may be defined as a CB (or CU) in a reference picture covering a particular sample location included in the current CB (or CU).

In one example, qPY_PRED may be derived as follows:

For a unidirectional inter-predicted CU at location (x,y),
qP_{Y_PRED}=QP_{ref},
where
QP_{ref} represents the value of the QP used to encode a collocated CU (x,y) in the reference picture.

For a bi-predicted inter-predicted CU at location (x,y),
qP_{Y_PRED}=(QP_{ref0}+QP_{ref1}+1)>>1,
where
QP_{ref0} and QP_{ref1} represent the value of the QP used to encode a collocated CU (x,y) in the reference picture, ref0, and reference picture, ref1, respectively.

For an intra-predicted CU at location (x,y),
qP_{Y_PRED}=QPᵢ₋₁,
where

QPᵢ₋₁ represents the value of the QP used by the CU to the left of the current CU. In one example, if the CU to the left is not available (e.g., the current CU is at the left edge of the picture), then the CU above shall be used. In one example, if neither the left nor above CU are available, sliceQP_{y} shall be used, where sliceQP_{y} is the QP for the slice containing CU (x,y).

It should be noted that in the example above, in the case of a bi-predicted inter-predicted CU, where two pictures are used for reference, additional and/or alternative functions (e.g., a minimum or maximum function) of the QP values from co-located CUs in the reference pictures may be used to determine qPY_PRED.

In one example, when a predictive QP value is derived from a QP value of a collocated region in a reference picture, signaling of delta QP values for each CU may be disabled. That is, cu_qp_delta_sign_flag and cu_qp_delta_abs may be excluded from a bitstream. In one example, when a predictive QP value is derived from a QP value of a collocated region in a reference picture, signaling of delta QP values for each CU may be enabled. That is, the luma QP, Qp′Y, may be computed as described above. It should be noted that in this case, the range on cu_qp_delta_abs may be limited and/or the binarization of cu_qp_delta_abs may be selected such that signaling of cu_qp_delta_abs requires less bit-rate overhead.

As described above, in some examples, a picture quantization map and a dQPChangeMap may be used to compute a predictive QP value for each region of the picture. Similarly, in one example, a predictive QP value derived from a QP value of a collocated region in a reference picture, a picture quantization map, and/or a dQPChangeMap may be used to compute a predictive QP value for each region of the picture. For example, QP value for a CU may be computed as follows:

For a unidirectional inter-predicted CU at location (x,y),
qP_{Y_PRED}=QP_{ref},
where
QP_{ref} represents the value of the QP used to encode a collocated CU (x,y) in the reference picture.

For a bi-predicted inter-predicted CU at location (x,y),
qP_{Y_PRED}=(QP_{ref0}+QP_{ref1}+1)>>1,
where
QP_{ref0} and QP_{ref1} represent the value of the QP used to encode a collocated CU (x,y) in the reference picture, ref0 and reference picture ref1, respectively.

For an intra-predicted CU at location (x,y),
qP_{Y_PRED}=QPᵢ₋₁,
where
QPᵢ₋₁ represents the value of the QP used by the CU to the left of the current CU. In one example, if the CU to the left is not available (e.g., the current CU is at the left edge of the picture), then the CU above shall be used. In one example, if neither the left nor above CU are available, sliceQP_{y} shall be used, where sliceQP_{y} is the QP for the slice containing CU (x,y).
Qp_{Y}=qP_{Y_PRED}+dQPMap[x] [y];
where
dQPMap[x] [y] is a 2-D array in units of CU that specifies the difference between the luma quantization parameter of the CU and qP_{Y_PRED}.

It should be noted that in a similar manner, in some examples, a predictive QP value derived from a qP_{Y_PRED} computed as a function of qP_{Y_A} and qP_{Y_B}, a picture quantization map, and/or a dQPChangeMap may be used to compute a predictive QP value for each region of the picture.

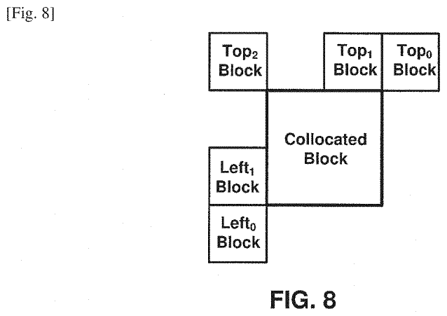

It should be noted that in one example, a predictive QP value may be derived from one or more possible QP values in a reference picture. For example, a predictive QP value may be derived from QP values corresponding to one or more candidate CUs (or CBs) included in a reference picture. For example, candidate CUs may include a collocated CU, a top neighboring CU to the collocated CU, including a top neighboring CU selected from a set of top neighboring CUs, and/or a left neighboring CU including a left neighboring CU selected from a set of left neighboring CUs, to the collocated CU. FIG. 8 is a conceptual diagram illustrating candidate CUs included in a reference picture according to one or more techniques of this disclosure. In one example, a video encoder and a video decoder may each be configured to derive a set of candidate CUs for generating a predictive QP. In one example, a video encoder and a video decoder may each be configured to derive a top neighboring CU (of CB) candidate from a set of top neighboring CUs. For example, referring to FIG. 8, in one example, a video encoder and a video decoder may each be configured to derive one of Top₀ Block, Top₁ Block, or Top₂ Block as a top neighboring candidate. In one example, a video encoder and a video decoder may each be configured to derive a left neighboring CU (or CB) candidate from a set of left neighboring CUs. For example, referring to FIG. 8, in one example, a video encoder and a video decoder may each be configured to derive one of Left₀ Block, and Left₁ Block as a left neighboring candidate. In one example, a video encoder and a video decoder may each be configured to derive a top neighboring CU (or CB) and/or a left neighboring CU (or CB) candidate based on block availability in a predetermined manner (e.g., select Top₀ Block as top candidate, if available and select Left₀ Block as left candidate, if available). In one example, after a set of candidates has been derived, a video encoder may select a candidate to use for a QP predictive value (i.e., the QP value corresponding to a candidate block) and signal an index value corresponding to one of the candidate CUs. Upon receiving the index value and deriving a candidate set in a manner similar to that of a video encoder, a video decoder may determine the corresponding predictive QP value, generate a QP value, and perform dequantization using the generated QP value.

As described above, examples of motion vector prediction include AMVP, TMVP, so-called “merge” mode, “skip” and “direct” motion inference, ATMVP, STMVP, PMMVD, and affine transform motion compensation prediction. According to the techniques described herein, techniques for deriving a predictive QP value from one or more possible QP values in a reference picture may be harmonized with a motion vector prediction techniques. For example, according to the techniques described herein, for a current CU, a motion vector may be specified to reference a candidate block in a reference picture and a QP value may be specified using the QP value of the same candidate block in a reference picture. In this manner, additional overhead is not incurred for signaling a candidate block in a reference picture for the purpose of generating a predictive QP value. Further, in this example, a video encoder and video decoder do not need to separately derive a set of candidate CUs for purposes of generating a predictive QP. It should be noted that in some cases, a candidate block in a reference picture for purposes of generating a motion vector predictor may include samples from multiple CUs and as such, the candidate block may be associated with multiple QP values. In these cases, a video encoder and a video decoder may each be configured to derive a predictive QP value from the multiple QP values. For example, in one example, a video encoder and a video decoder may each be configured to derive a predictive QP value by averaging the multiple QP values. In one example, a video encoder and a video decoder may each be configured to derive a predictive QP value selecting one of the multiple QP values based on a spatial location (e.g., select the top-left most CU in the candidate block). In one example, a video encoder and a video decoder may each be configured to derive a predictive QP value selecting one of the multiple QP values by selecting the CU in the reference picture that most overlaps the current CU. It should be noted that if multiple CUs in the candidate block have the same degree of overlap, a tie-breaking process may be specified, such that one of the multiple CUs is uniquely selected (e.g., the top-left most CU may be selected).

In one example, when a motion vector is specified to reference a candidate block in a reference picture and a QP value is specified using the QP value of the candidate block, signaling of delta QP values for each CU may be disabled. In one example, when a motion vector is specified to reference a candidate block in a reference picture and a QP value is specified using the QP value of the candidate block, signaling of delta QP values for each CU may be enabled. It should be noted that in this case, the range on cu_qp_delta_abs may be limited and/or the binarization of cu_qp_delta_abs may be selected such that signaling of cu_qp_delta_abs requires less bit-rate overhead. Computing qP_{Y_PRED} using a QP value corresponding to a reference video block may generally be referred to as a qP_{Y_PRED}=func(QP_{ref}) QP prediction mode. That is, in these cases qP_{Y_PRED} is a function of the QP value corresponding to a reference video block.

As described above, video encoder 200 may be configured to signal the QP prediction mode that is used to compute qPY_PRED such that a video decoder uses the same QP prediction mode to compute qPY_PRED during a dequantization process. In one example, video encoder 200 may be configured to signal a QP prediction mode in the slice header, PPS, and/or SPS according to a codeword. Table 1 provides an example of codewords that may be used to signal one of: a qP_{Y_PRED}=func(qP_{Y_A}, qP_{Y_B}) QP prediction mode; a qP_{Y_PRED}=func(dQPMap[x] [y])) QP prediction mode; or a qP_{Y_PRED}=func(QP_{ref}) QP prediction mode, where examples of the QP prediction modes are described above.

TABLE 1

| Codeword | qP_{Y}_{_{—}}_{PRED} Computation Method |
|---|---|
| 00 | qP_{Y}_{_{—}}_{PRED} = func(qP_{Y}_{_{—}}_{A,} qP_{Y}_{_{—}}_{B}) |
| 01 | qP_{Y}_{_{—}}_{PRED} = func(dQPMap[x][y]) |
| 10 | qP_{Y}_{_{—}}_{PRED} = func(QP_{ref}) |

It should be noted that each of the QP prediction modes included in Table 1 compute qP_{Y_PRED} independent of sample values included in video data. That is, qP_{Y_PRED} is computed independent of the visual characteristics of a picture. According to techniques described herein, in some examples, qP_{Y_PRED} may be computed based on samples values of video data. For example, qP_{Y_PRED} for a current video block may be computed based on the average intensity of luma samples included in a reference video block.

According to the techniques described herein, in one example, qPY_PRED may be derived for a block as follows:
qP_{Y_PRED}=sliceQP+dQP_{SV};
where dQP_{SV} is a function of sample values included in a reference video block.

Computing qP_{Y_PRED} as provided in the equation above, may generally be referred to as a qP_{Y_PRED}=func(sample values) QP prediction mode.

International Application No. PCT/JP2016/002761, filed 7 Jun. 2016 and published on 15 Dec. 2016 as WO 2016/199409 A1, which is subject to a common assignment obligation, and incorporated by reference herein, describes where the quantization parameter for a CU may be determined as a function of a scaling factor (e.g., A), multiplied by an average luma value for a block of video data, (e.g., LumaAverage), plus an offset value (e.g., Offset). That is, WO 2016/199409 A1 describes where a quantization parameter may be based on the following function:

A*LumaAverage+Offset

WO 2016/199409 A1 further describes where A*LumaAverage+Offset may be added to a predictor quantization parameter value (e.g., a slice QP value or a CTU QP value) to derive a quantization parameter value for a CU.

WO 2016/199409 A1 further describes where the quantization parameter for a CU may be determined based on the following function including A, LumaAverage, and Offset:

max(A*LumaAverage+Offset, Constant)
where
max(x,y) returns x, if x is greater than or equal to y, and returns y, if y is greater than x.

WO 2016/199409 A1 describes where the term max(A*LumaAverage+Offset, Constant) may be added to a predictor quantization parameter value to derive a quantization parameter value for a CU. WO 2016/199409 A1 describes where in one example, the value of A may be within the range of 0.01 to 0.05 and in one example, may be equal to 0.03; where the value of Offset may be within the range of −1 to −6 and in one example, may be equal to −3; and where the value of Constant may be within the range of −1 to 1 and in one example, may be equal to 0. In one example, the value of dQP_{SV} which is added to sliceQP to compute qPY_PRED in the equation above may be based on A*LumaAverage+Offset, according to techniques described in WO 2016/199409 A1.

In one example, the value of dQP_{SV} may be determined based on one or more look-up tables. For example, an average luma value for a reference block of video data may be indexed to a dQP_{SV} value. For a current block of video data, a reference block of video may include, for example, (i) one or more collocated blocks, (ii) a block forming a motion compensated prediction and/or (iii) one or more spatial neighboring blocks. Further, it should be noted that in some examples, a bit-stream may include a dQP_{SV} value for a current CU. For example, a bit-stream may include a dQP_{SV} value when a reference block is not available. Further, in some examples, when a reference block is not available, a default value may be assigned to dQP_{SV} and/or an average luma value. Table 2 illustrates an example of a look-up table, where an average luma value for a reference block of video data is indexed to a dQP_{SV} value.

TABLE 2

| LumaAverage range | dQP_{SV} |
|---|---|
| LumaAverage < 301 | 3 |
| 301 ≤ LumaAverage < 367 | 2 |
| 367 ≤ LumaAverage < 434 | 1 |
| 434 ≤ LumaAverage < 501 | 0 |
| 501 ≤ LumaAverage < 567 | −1 |
| 567 ≤ LumaAverage < 634 | −2 |
| 634 <= LumaAverage < 701 | −3 |
| 701 <= LumaAverage < 767 | −4 |
| 767 <= LumaAverage < 834 | −5 |
| LumaAverage >= 834 | −6 |

It should be noted that the example illustrated in Table 2 may correspond to an example in ITU-T H.265, where the bit-depth of the luma component is 10-bits and thus, ranges from 0 to 1023. In other examples, different look-up tables may be specified for various bit-depths, e.g., 8-bits, 12-bits, etc. Further, in one example, video encoder 200 may be configured to signal a particular look-up table to determine dQP_{SV}In one example, video encoder 200 may be configured to signal a look-up table by signaling an array of delimiter values. For example, video encoder 200 may be configured to signal Table 2 as follows:
Let numDelimitValues equal the number of luma delimiter values and lumaDelimitValues[numDelimitValues] be an array of delimiter values:
numDelimitValues=9;
lumaDelimitValues[0]=301;
lumaDelimitValues[1]=367;
lumaDelimitValues[2]=434;
lumaDelimitValues[3]=501;
lumaDelimitValues[4]=567;
lumaDelimitValues[5]=634;
lumaDelimitValues[6]=701;
lumaDelimitValues[7]=767;
lumaDelimitValues[8]=834;

In one example, the values for numDelimitValues and the lumaDelimitValues array may be signaled in the SPS and/or the PPS. Further, in one example, an initial look-up table may be signaled in the SPS or the PPS and updated at the PPS or the slice level. In the case where the values for numDelimitValues and the lumaDelimitValues are signaled, a corresponding video decoder would be configured to parse the values of numDelimitValues and the lumaDelimitValues from the bitstream and generate a corresponding look-up table for determining how an average lumavalue for a reference block of video data is indexed to a dQP_{SV} value.

As described above, components of video data may be associated with bit-depths. Similarly, video coding standards can indicate that the compressed video data is associated with a particular media profile, where a media profile may include, for example, a defined color space, an electro-optical transfer function, and a bit-depth in order to associate intensity values of color components to a color that is rendered on a display device. For example, the so-called HDR10 media profile, uses the wide-gamut Rec. 2020 color space, a bit depth of 10-bits, and the SMPTE ST 2084 electro-optical transfer function and the so-called Hybrid Log-Gamma (HLG), uses the wide-gamut Rec. 2020 color space, a bit depth of 10-bits or 12-bits, and a nonlinear transfer function in which the lower half of the signal values use a gamma curve and the upper half of the signal values use a logarithmic curve. In one example, according to the techniques described herein, video encoder 200 may be configured such that respective look-up tables correspond to indicated media profiles. For example, different media profiles may be associated with distinct non-linear indexing of an average luma value for a reference block of video data to a dQP_{SV} value, e.g., in order to correspond to a particular an electro-optical transfer function.

In one example, when dQP_{SV} is used to compute a predictive QP value, signaling of delta QP values for each CU may be enabled. That is, the luma QP, Qp′Y, may be computed in manner similar to that described above, with respect to ITU-T H.265.

As described above, video encoder 200 may be configured to signal the QP prediction mode that is used to compute qPY_PRED such that a video decoder uses the same QP prediction mode to compute qPY_PRED during a dequantization process. Table 3 provides an example of codewords that may be used to signal one of: a qP_{Y_PRED}=func(qP_{Y_A}, qP_{Y_B}) QP prediction mode; a qP_{Y_PRED}=func(dQPMap[x] [y])) QP prediction mode; a qP_{Y_PRED}=func(QP_{ref}) QP prediction mode; or a qP_{Y_PRED}=func(sample values) prediction mode, where examples of the QP prediction modes are described above.

TABLE 3

| Codeword | qP_{Y}_{_{—}}_{PRED} Computation Method |
|---|---|
| 00 | qP_{Y}_{_{—}}_{PRED} = func(qP_{Y}_{_{—}}_{A}, qP_{Y}_{_{—}}_{B}) |
| 01 | qP_{Y}_{_{—}}_{PRED} = func(dQPMap[x][y]) |
| 10 | qP_{Y}_{_{—}}_{PRED} = func(QP_{ref}) |
| 11 | qP_{Y}_{_{—}}_{PRED} = func(sample values) |

As described above, rate control (RC) algorithms may refer to algorithms that code video data according to a specified bit-rate and frequently use the statistical variance of a residual to select a QP value. Ribas-Corbera, J. et al., Rate Control for Low-Delay Video Communications, Contribution Q15-A-20 to ITU-T Video Coding Experts Group First Meeting (ITU-T SG16 Q.15 Study Period 1997-2000), Portland, Oreg., USA, June 1997, which is incorporated by reference herein, and referred to as Ribas-Corbera, describes a rate control technique that adapts the QP for macroblocks within a frame according to optimized bit allocation strategy. It should be noted that as described above, ITU-T H.265 specifies a CTU (also referred to as LCU) structure, which is analogous to the 16×16 macroblock in predecessor video coding standards. Thus, as described in further detail below, the techniques described in Ribas-Corbera may be applied to CUs having a size other than 16×16. Ribas-Corbera describes where Q, the quantization step size for the i-th macroblock, is computed based on the optimized quantization step size, Qᵢ*. It should be noted that Ribas-Corbera is based on a video coding standard where QP=2*Qᵢ. In ITU-T H.265, Qᵢ=2^{(QP-4)/6} for most profiles. In particular, Ribas-Corbera describes where for a picture having N macroblocks and B being the total number of bits allocated for encoding the picture, Qᵢ is computed based on the optimized quantization step size, Qᵢ*, which is specified as follows:

$${Q}_{i}^{*} = \sqrt{\frac{A {K}_{i - 1} {σ}_{i}}{( B - A N {C}_{i - 1} )} {\sum }_{k = 1}^{N} {σ}_{k}}$$

where,
A is the number of samples in a macroblock;
B is the total number of bits B allocated for encoding the picture;
N is the number of macroblocks in the picture;
σᵢ is the empirical standard deviation of the difference between the prediction and original luma and chroma samples in the i-th macroblock; and

$${K}_{i - 1} = \frac{{{B}_{LC , i - 1}^{′} ( {Q}_{i - 1} )}^{2}}{A {σ}_{i - 1}^{2}} , and {C}_{i - 1} = \frac{{B}_{i - 1}^{′} - {B}_{LC , i - 1}^{′}}{A} ,$$

where B_{LC,i}′ is the number of bits used to encode the luma and chroma of the i-th macroblock and B′ᵢ is the actual number of bits used to encode the DCT coefficients of the i-th macroblock.

From the optimized quantization parameter in Ribas-Corbera, a relationship between variance and quantization step size may be derived as follows:

Let

$${B}_{LC , i}^{′} = \frac{B}{N}$$

and Bᵢ′=B_{LC,i}′−bᵢ′ where bᵢ′ is the number of bits in the i-th marcoblock that are not associated with the DCT coefficients (e.g., bits used to code prediction modes, etc.).

Further, let

$${b}_{i}^{′} = \frac{b}{N}$$

where b is the number of bits in the picture not associated with the DCT coefficients.

Substituting these expressions into those for Kᵢ₋₁ and Cᵢ₋₁ yields:

$${K}_{i - 1} = \frac{\frac{B}{N} {( {Q}_{i - 1} )}^{2}}{A {σ}_{i - 1}^{2}} and {C}_{i - 1} = C = \frac{- b}{A N} .$$

Further substituting the above expressions for Kᵢ₋₁ and Cᵢ₋₁ into the expression for Qᵢ* and simplifying yields:

$${Q}_{i}^{*} = {Q}_{i - 1} \sqrt{\frac{{σ}_{i} \frac{1}{N} {\sum }_{k = 1}^{N} {σ}_{k}}{{σ}_{i - 1}^{2}} \times \frac{1}{1 + \frac{b}{B}}}$$

For ITU-T H.265 an expression for quantization step size, Qᵢ, may be derived as:

$${Q}_{i} = {2}^{( {qP}_{Y \_ PRED} - 4 ) / 6} = {2}^{( {QP}_{i - 1} - 4 ) / 6} \sqrt{\frac{{σ}_{i} \frac{1}{N} {\sum }_{k = 1}^{N} {σ}_{k}}{{σ}_{i - 1}^{2}} \times \frac{1}{1 + \frac{b}{B}}}$$

Solving for qPY_PRED in the equation above yields:

$$q {P}_{{Y}_{P R E D}} = Q {P}_{t - 1} + 3 {log}_{2} [ \frac{{σ}_{i} \frac{1}{N} {\sum }_{k = 1}^{N} {σ}_{k}}{{σ}_{i - 1}^{2}} \times \frac{1}{1 + \frac{b}{B}} ]$$

Further, in the equation above, QPᵢ₋₁ may be replaced with qP_{Y_A}, described above, thus, according to the techniques described herein, video encoder 200 may be configured to determine qP_{Y_PRED} based on the following equation:

$$q {P}_{{Y}_{P R E D}} = Q {P}_{Y \_ A} + 3 {log}_{2} [ \frac{{σ}_{i} \frac{1}{N} {\sum }_{k = 1}^{N} {σ}_{k}}{{σ}_{i - 1}^{2}} \times \frac{1}{1 + \frac{b}{B}} ]$$

Computing qP_{Y_PRED} based on the equation above, may generally be referred to as a qP_{Y_PRED}=func(residual variance) QP prediction mode.

It should be noted that in the equation above,
The term

$$\frac{1}{1 + \frac{b}{B}}$$

accounts for the fact that QP affects only the bit rate of the DCT coefficients and can be estimated using previously coded frames and/or set to a constant.
The value of σᵢ₋₁² can be estimated by the decoder by computing the variance of the decoded luma and chroma coefficient values of the previous CU.
The value of

$$\frac{1}{N} {\sum }_{k = 1}^{N} {σ}_{k}$$

can estimated as the average of the standard deviation of the luma and chroma coefficient values of previously decoded CUs in the picture.
The value of σᵢ can be estimated using the empirical standard deviation of estimates for the decoded luma and chroma coefficient values in the i-th CU. It should be noted that it is necessary to know the QP value associated with the i-th CU in order to decode its luma and chroma coefficients. Because the QP value of the i-th CU is not known a priori, an estimate of its value may be used instead. In one example, the QP associated with the i-th CU may be estimated as the arithmetic average of the QP's associated with all CU's in the picture that have been decoded prior to the i-th CU. The QP for the first CU in the picture may be estimated as the picture QP value.

Thus, according to the techniques described herein, video encoder 200 may be configured to determine qP_{Y_PRED} based on the following equation:

$$q {P}_{{Y}_{P R E D}} = {qP}_{Y \_ A} + 3 {log}_{2} [ \frac{{σ}_{i}^{*} \times S {D}_{avg \_ p}}{{Var}_{i - 1}} \times C ]$$

where,
σᵢ* is the estimated empirical standard deviation of the difference between the prediction and original luma and chroma values in the current CU;
SD_{avg_P} is the average of the standard deviation of the luma and chroma coefficient values of previously decoded CUs in the picture;
Varᵢ₋₁ the variance of the decoded luma and chroma coefficient values of the previous CU; and
C is a predetermined constant.

In this manner, video encoder 200 is configured to determine qP_{Y_PRED} of a current CU by adjusting the QP value of a previously coded CU based on whether the product of σᵢ* times SD_{avg_P} is greater than Varᵢ₋₁ in which case qP_{Y_PRED} of a current CU is adjusted to be greater than the QP of the previously coded CU.

It should be noted that with respect to the term

$$3 {log}_{2} [ \frac{{σ}_{i}^{*} \times S {D}_{avg \_ p}}{{Var}_{i - 1}} \times C ]$$

in the equation above, the scaling factor of 3 results from a theoretical derivation. In some examples, it may be advantageous to use a different constant that may be derived empirically. That is, in some examples a scaling factor other than 3 may be used.

It should be noted that with respect to C, the value of b/B is constrained based on the video coding standard. That is, a video coding standard has a theoretical minimum and a maximum value of b/B. Further, the value of the QP affects the value of b/B, as for high QP values, fewer bits are used to encode the DCT coefficients thereby increasing b/B. A theoretical maximum value of b/B would be 1, since it is possible for the QP to be high enough such that all coefficient levels equal zero (i.e., zero bits are used to encode the coefficient values). A theoretical minimum value of b/B would be dependent on a video coding standard. A typical value of b/B would be dependent on a target bit rate. In a typical case for high quality video, for example, b/B would be approximately 0.3, and C would be equal to 0.77. For purposes of description on the techniques described herein, in an encoded picture, b/B may be described as typically being in the range of 0.25 to 0.75, and thus, C would typically be within the range of 0.5714 to 0.8.

It should be noted that in the equation above, a term ((σᵢ*SD_{avg_P})/Varᵢ₋₁) indicates the relative prediction accuracy of the current CU, since accurate prediction leads to low residual variance and inaccurate prediction leads to high residual variance. That is, Varᵢ₋₁ is an indication of the prediction accuracy of the previous CU and if σᵢ is relatively large, which indicates that the prediction accuracy of the current CU is relatively poor, (σᵢ*SD_{avg_P}) is likely to be greater than Varᵢ₋₁. When (σᵢ*SD_{avg_P}) is greater than Varᵢ₋₁,

$${log}_{2} [ \frac{{σ}_{i}^{*} \times S {D}_{avg \_ p}}{{Var}_{i - 1}} \times C ]$$

is typically positive and qP_{Y_PRED} is increased compared to qP_{Y_A}. Likewise, when (σᵢ*SD_{avg_P}) is less than Varᵢ₋₁,

$${log}_{2} [ \frac{{σ}_{i}^{*} \times S {D}_{avg \_ p}}{{Var}_{i - 1}} \times C ]$$

is typically less than zero and qP_{Y_PRED} is decreased compared to qP_{Y_A}. It should be noted that well predicted regions of a picture may correspond to visually important areas of a picture (e.g., a face) and poorly predicted regions of a picture may correspond to visually unimportant areas of a picture (e.g., high texture regions, such as leaves of a tree). In this manner, video encoder 200 is configured to determine qP Y_PRED of a current CU by adjusting the QP value of a previously coded CU based on the relative prediction quality of the current CU, where quantization is increased if the CU is relatively poorly predicted and decreased if the CU is relatively highly predicted.

As described above, increasing the accuracy of a quantization parameter predictive value may result in a bit rate savings as cu_qp_delta_abs and cu_qp_delta_sign_flag may be signaled less frequently. Further, according to the techniques described herein, signaling a customized function for qP_{Y_PRED} in a bitstream may increase the accuracy of qP_{Y_PRED} such that bits used to signal the customized function are offset by the bit savings resulting from the increase in the accuracy of qP_{Y_PRED}. For example, at bit rates typical of broadcast communications, the signaling overhead for sending frequent delta QP values can be as high as 3%. Halving that overhead by using better prediction could result in a significant bit rate savings as high as 2%, which would be much larger than the bit rate overhead associated with signaling a customized function once per picture or less frequently. That is, video coding efficiency may be increased in the example where video encoder 200 is configured to signal a customized function for determining qP_{Y_PRED}.

In one example, video encoder 200 may be configured to signal a qP_{Y_PRED}=func(residual_variance) using customized using parameters signaled in the bitstream. For example, a bitstream may signal how video statistics (e.g., current CU mean (luma), current CU variance (luma), average of previously coded CUs in the picture, previous CU variance (luma), current CU edge energy) may be used to compute qP_{Y_PRED}. For example, a bitstream may signal how the value of
(SD_{avg_p}/Varᵢ₋₁)

is estimated. In one example, each video statistic, arithmetic operation, and/or arithmetic delimiter used to calculate qP_{Y_PRED} in a qP_{Y_PRED}=func(residual_variance) QP prediction mode would be specified using a unique code. In one example, each video statistic may be pre-computed by a video decoder in a specified fashion and an expression used to compute qP_{Y_PRED} may be expressed in the bitstream using a code string. When the code for a particular video statistic is parsed, the pre-computed value associated with that statistic would be used. Further, the bitstream may signal the value of C. In one example, the values for constants, e.g., C may be coded explicitly in the bitstream, for example, using an Exponential Golomb code.

In one example, a qPY_PRED code string may be conveyed in the PPS, SPS, and/or slice header. For example, the following code string may be used to convey the equation above.
QP previous CU; add; log base 2; open parens; current CU standard deviation; multiply; average of standard deviations of previously coded CUs; divide; previous CU variance; multiply by a specified constant (i.e., 1/(1+b/B)); closed parens; multiply by a specified constant (i.e., 3),

Alternatively, in one example, a multi-dimensional look-up table with current CU standard deviation, current CU mean, current CU edge energy, and previous CU variance may be used as indices to reference the desired QP prediction.

As described above, video encoder 200 may be configured to signal the QP prediction mode that is used to compute qPY_PRED such that a video decoder uses the same QP prediction mode to compute qPY_PRED during a dequantization process. Table 4 provides an example of codewords that may be used to signal one of: a qP_{Y_PRED}=func(qP_{Y_A}, qP_{Y_B}) QP prediction mode; a qP_{Y_PRED}=func(dQPMap[x] [y])) QP prediction mode; a qP_{Y_PRED}=func(QP_{ref}) QP prediction mode; a qP_{Y_PRED}=func(sample values) prediction mode, or a qP_{Y_PRED}=func(residual variance) QP prediction mode where examples of the QP prediction modes are described above.

TABLE 4

| Codeword | qP_{Y}_{_{—}}_{PRED} Computation Method |
|---|---|
| 00001 | qP_{Y}_{_{—}}_{PRED} = func(sample values) |
| 00010 | qP_{Y}_{_{—}}_{PRED} = func(residual_variance) |
| 00100 | qP_{Y}_{_{—}}_{PRED} = func(dQPMap[x][y]) |
| 01000 | qP_{Y}_{_{—}}_{PRED} = func(qP_{Y}_{_{—}}_{A}, qP_{Y}_{_{—}}_{B}) |
| 10000 | qP_{Y}_{_{—}}_{PRED} = func(QP_{ref}) |

Referring again to FIG. 6, quantized transform coefficients are output to inverse quantization/transform processing unit 208. Inverse quantization/transform processing unit 208 may be configured to apply an inverse quantization and an inverse transformation to generate reconstructed residual data. As further illustrated in FIG. 6, at summer 210, reconstructed residual data may be added to a predictive video block. In this manner, an encoded video block may be reconstructed and the resulting reconstructed video block may be used to evaluate the encoding quality for a given prediction, transformation, and/or quantization. Video encoder 200 may be configured to perform multiple coding passes (e.g., perform encoding while varying one or more of a prediction, transformation parameters, and quantization parameters). The rate-distortion of a bitstream or other system parameters may be optimized based on the evaluation of reconstructed video blocks. Further, reconstructed video blocks may be stored and used as reference for predicting subsequent blocks.

As described above, a video block may be coded using an intra prediction. Intra prediction processing unit 212 may be configured to select an intra prediction mode for a video block to be coded. Intra prediction processing unit 212 may be configured to evaluate a frame and/or an area thereof and determine an intra prediction mode to use to encode a current block. As illustrated in FIG. 6, intra prediction processing unit 212 outputs intra prediction data (e.g., syntax elements) to entropy encoding unit 218 and transform coefficient generator 204. As described above, a transform performed on residual data may be mode dependent. As described above, possible intra prediction modes may include planar prediction modes, DC prediction modes, and angular prediction modes. Further, in some examples, a prediction for a chroma component may be inferred from an intra prediction for a luma prediction mode.

Inter prediction processing unit 214 may be configured to perform inter prediction coding for a current video block. Inter prediction processing unit 214 may be configured to receive source video blocks and calculate a motion vector for PUs of a video block. A motion vector may indicate the displacement of a PU (or similar coding structure) of a video block within a current video frame relative to a predictive block within a reference frame. Inter prediction coding may use one or more reference pictures. Further, motion prediction may be uni-predictive (use one motion vector) or bi-predictive (use two motion vectors). Inter prediction processing unit 214 may be configured to select a predictive block by calculating a pixel difference determined by, for example, sum of absolute difference (SAD), sum of square difference (SSD), or other difference metrics. As described above, a motion vector may be determined and specified according to motion vector prediction. Inter prediction processing unit 214 may be configured to perform motion vector prediction, as described above. Inter prediction processing unit 214 may be configured to generate a predictive block using the motion prediction data. For example, inter prediction processing unit 214 may locate a predictive video block within a frame buffer (not shown in FIG. 6). It should be noted that inter prediction processing unit 214 may further be configured to apply one or more interpolation filters to a reconstructed residual block to calculate sub-integer pixel values for use in motion estimation. Inter prediction processing unit 214 may output motion prediction data for a calculated motion vector to entropy encoding unit 218. As illustrated in FIG. 6, inter prediction processing unit 214 may receive reconstructed video block via post filter unit 216. Post filter unit 216 may be configured to perform deblocking and/or Sample Adaptive Offset (SAO) filtering. Deblocking refers to the process of smoothing the boundaries of reconstructed video blocks (e.g., make boundaries less perceptible to a viewer). SAO filtering is a non-linear amplitude mapping that may be used to improve reconstruction by adding an offset to reconstructed video data.

Referring again to FIG. 6, entropy encoding unit 218 receives quantized transform coefficients and predictive syntax data (i.e., intra prediction data, motion prediction data, QP data, etc.). It should be noted that in some examples, coefficient quantization unit 206 may perform a scan of a matrix including quantized transform coefficients before the coefficients are output to entropy encoding unit 218. In other examples, entropy encoding unit 218 may perform a scan. Entropy encoding unit 218 may be configured to perform entropy encoding according to one or more of the techniques described herein. Entropy encoding unit 218 may be configured to output a compliant bitstream, i.e., a bitstream that a video decoder can receive and reproduce video data therefrom. In this manner, video encoder 200 represents an example of a device configured to determine a predictive quantization parameter for an array of level values based at least in part on one or more of: a picture quantization map and a quantization parameter value of a video block included in a reference picture, generate a quantization parameter for the array based at least in part on the determined predictive quantization parameter, and perform an inverse quantization operation on the array using the generated quantization parameter.

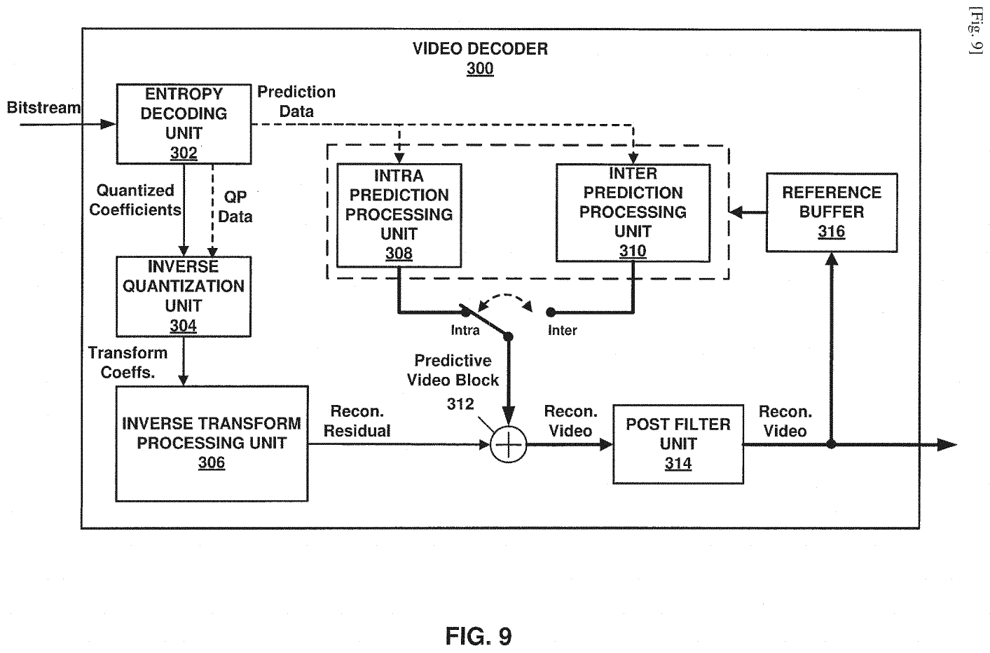

FIG. 9 is a block diagram illustrating an example of a video decoder that may be configured to decode video data according to one or more techniques of this disclosure. In one example, video decoder 300 may be configured to reconstruct video data based on one or more of the techniques described above. That is, video decoder 300 may operate in a reciprocal manner to video encoder 200 described above. Video decoder 300 may be configured to perform intra prediction decoding and inter prediction decoding and, as such, may be referred to as a hybrid decoder. In the example illustrated in FIG. 9 video decoder 300 includes an entropy decoding unit 302, inverse quantization unit 304, inverse transformation processing unit 306, intra prediction processing unit 308, inter prediction processing unit 310, summer 312, post filter unit 314, and reference buffer 316. Video decoder 300 may be configured to decode video data in a manner consistent with a video encoding system, which may implement one or more aspects of a video coding standard. It should be noted that although example video decoder 300 is illustrated as having distinct functional blocks, such an illustration is for descriptive purposes and does not limit video decoder 300 and/or sub-components thereof to a particular hardware or software architecture. Functions of video decoder 300 may be realized using any combination of hardware, firmware, and/or software implementations.

As illustrated in FIG. 9, entropy decoding unit 302 receives an entropy encoded bitstream. Entropy decoding unit 302 may be configured to decode quantized syntax elements and quantized coefficients from the bitstream according to a process reciprocal to an entropy encoding process. Entropy decoding unit 302 may be configured to perform entropy decoding according any of the entropy coding techniques described above. Entropy decoding unit 302 may parse an encoded bitstream in a manner consistent with a video coding standard. Video decoder 300 may be configured to parse an encoded bitstream where the encoded bitstream is generated based on the techniques described above.

Referring again to FIG. 9, inverse quantization unit 304 receives quantized transform coefficients (i.e., level values) and quantization parameter data from entropy decoding unit 302. Quantization parameter data may include any and all combinations of delta QP values and/or quantization group size values and the like described above. Video decoder 300 and/or inverse quantization unit 304 may be configured to determine QP values used for inverse quantization based on values signaled by a video encoder and/or through video properties and/or coding parameters. That is, inverse quantization unit 304 may operate in a reciprocal manner to coefficient quantization unit 206 described above. For example, video decoder 300 may be configured to determine a QP mode, determine a predictive QP value based on the QP mode, and determine a QP value based on the predictive QP mode. In one example, video decoder 300 may be configured to determine a predictive QP value based on any and all combinations of the techniques described above.

Inverse quantization unit 304 may be configured to apply an inverse quantization. Inverse transform processing unit 306 may be configured to perform an inverse transformation to generate reconstructed residual data. The techniques respectively performed by inverse quantization unit 304 and inverse transform processing unit 306 may be similar to techniques performed by inverse quantization/transform processing unit 208 described above. Inverse transform processing unit 306 may be configured to apply an inverse DCT, an inverse DST, an inverse integer transform, Non-Separable Secondary Transform (NSST), or a conceptually similar inverse transform processes to the transform coefficients in order to produce residual blocks in the pixel domain. Further, as described above, whether a particular transform (or type of particular transform) is performed may be dependent on an intra prediction mode. As illustrated in FIG. 9, reconstructed residual data may be provided to summer 312. Summer 312 may add reconstructed residual data to a predictive video block and generate reconstructed video data. A predictive video block may be determined according to a predictive video technique (i.e., intra prediction and inter frame prediction).

Intra prediction processing unit 308 may be configured to receive intra prediction syntax elements and retrieve a predictive video block from reference buffer 316. Reference buffer 316 may include a memory device configured to store one or more frames of video data. Intra prediction syntax elements may identify an intra prediction mode, such as the intra prediction modes described above. In one example, intra prediction processing unit 308 may reconstruct a video block using according to one or more of the intra prediction coding techniques described herein. Inter prediction processing unit 310 may receive inter prediction syntax elements and generate motion vectors to identify a prediction block in one or more reference frames stored in reference buffer 316. Inter prediction processing unit 310 may produce motion compensated blocks, possibly performing interpolation based on interpolation filters. Identifiers for interpolation filters to be used for motion estimation with sub-pixel precision may be included in the syntax elements. Inter prediction processing unit 310 may use interpolation filters to calculate interpolated values for sub-integer pixels of a reference block. Post filter unit 314 may be configured to perform filtering on reconstructed video data. For example, post filter unit 314 may be configured to perform deblocking and/or SAO filtering, as described above with respect to post filter unit 216. Further, it should be noted that in some examples, post filter unit 314 may be configured to perform proprietary discretionary filter (e.g., visual enhancements). As illustrated in FIG. 9, a reconstructed video block may be output by video decoder 300. In this manner, video decoder 300 represents an example of a device configured to determine a predictive quantization parameter for an array of level values based at least in part on one or more of: a picture quantization map and a quantization parameter value of a video block included in a reference picture, generate a quantization parameter for the array based at least in part on the determined predictive quantization parameter, and perform an inverse quantization operation on the array using the generated quantization parameter. In this manner, video decoder 300 may be configured to generate reconstructed video data according to one or more of the techniques described herein.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Moreover, each functional block or various features of the base station device and the terminal device used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

Various examples have been described. These and other examples are within the scope of the following claims.

1-16. (canceled)

17: A method of decoding video data, the method comprising:
1) determining a predictive quantization parameter qPY PRED for a current quantization group, wherein determining the predictive quantization parameter qPY_PRED includes:
determining whether a left quantization parameter qPY_A for a left coding block to left of the current quantization group is available;
determining whether an upper quantization parameter qPY_B for an upper coding block above the current quantization group is available;
when both the left quantization parameter qPY_A and the upper quantization parameter qPY_B are available, determining the predictive quantization parameter qPY_PRED by an equation qPY_PRED=(qPY_A+qPY_B+1)>>1; and
when the left quantization parameter qPY_A is not available and the upper quantization parameter qPY_B is available, determining the predictive quantization parameter qPY_PRED by an equation qPY_PRED=qPY_B;
2) generating a quantization parameter for the current quantization group at least in part depending on the determined predictive quantization parameter qPY_PRED; and
3) performing an inverse quantization operation using the generated quantization parameter.

18: The method of claim 17, wherein determining the predictive quantization parameter qPY_PRED, further includes, when neither the left quantization parameter qPY_A nor the upper quantization parameter qPY_B are available, determining the predictive quantization parameter qPY_PRED by setting equal to a slice level quantization parameter.

19: The method of claim 17, wherein generating the quantization parameter includes adding a quantization parameter delta value to the predictive quantization parameter qPY_PRED.

20: The method of claim 18, wherein the slice level quantization parameter is determined based on a syntax element signaled in a slice header.

21: A device of decoding video data comprising:
a memory and
a processor, wherein the processor is configured to perform steps of:
1) determining a predictive quantization parameter qPY PRED for a current quantization group, wherein determining the predictive quantization parameter qPY_PRED includes:
determining whether a left quantization parameter qPY_A for a left coding block to left of the current quantization group is available;
determining whether an upper quantization parameter qPY_B for an upper coding block above the current quantization group is available;
when both the left quantization parameter qPY_A and the upper quantization parameter qPY_B are available, determining the predictive quantization parameter qPY_PRED by an equation qPY_PRED=(qPY_A+qPY_B+1)>>1; and
when the left quantization parameter qPY_A is not available and the upper quantization parameter qPY_B is available, determining the predictive quantization parameter qPY_PRED by an equation qPY_PRED=qPY_B;
2) generating a quantization parameter for the current quantization group at least in part depending on the determined predictive quantization parameter qPY_PRED; and
3) performing an inverse quantization operation using the generated quantization parameter.

22: A method of coding video data, the method comprising:
1) determining a predictive quantization parameter qPY_PRED for a current quantization group, wherein determining the predictive quantization parameter qPY_PRED includes:
determining whether a left quantization parameter qPY_A for a left coding block to left of the current quantization group is available;
determining whether an upper quantization parameter qPY_B for an upper coding block above the current quantization group is available;
when both the left quantization parameter qPY_A and the upper quantization parameter qPY_B are available, determining the predictive quantization parameter qPY_PRED by an equation qPY_PRED=(qPY_A+qPY_B+1)>>1; and
when the left quantization parameter qPY_A is not available and the upper quantization parameter qPY_B is available, determining the predictive quantization parameter qPY_PRED by an equation qPY_PRED=qPY_B;
2) generating a quantization parameter for the current quantization group at least in part depending on the determined predictive quantization parameter qPY_PRED; and
3) performing an inverse quantization operation using the generated quantization parameter.
